(19) United States
(12) Patent Application Publication
(10) Pub. No.: US 2022/0156762 A1
(43) Pub. Date: May 19, 2022

(54) METHODS AND APPARATUS TO DETERMINE CENSUS AUDIENCE MEASUREMENTS

(71) Applicant: The Nielsen Company (US), LLC, New York, NY (US)

(72) Inventors: Michael Richard Sheppard, Holland, MI (US); DongBo Cui, New York, NY (US); David Forteguerre, Brooklyn, NY (US); Jessica Lynn White, Plant City, FL (US); Edward Murphy, North Stonington, CT (US); Diane Morovati Lopez, West Hills, CA (US)

(21) Appl. No.: 17/526,450

(22) Filed: Nov. 15, 2021

Related U.S. Application Data
(60) Provisional application No. 63/114,359, filed on Nov. 16, 2020.

(51) Int. Cl. G06Q 30/02

(52) U.S. Cl. CPC G06Q 30/0201

(57) ABSTRACT

Methods, apparatus, systems, and articles of manufacture are disclosed to determine census audience measurements. An example apparatus includes statistics generator circuitry to select a plurality of constraint equations based on census audience measurement data corresponding to a first demographic group and a second demographic group, bounds generator circuitry to determine bounds for multipliers for ones of the constraint equations based on the census audience measurement data, multiplier controller circuitry to determine a value for ones of the multipliers based on the bounds, the value to satisfy the constraint equations, census-level metrics generator circuitry to determine first census audience measurement information and second census audience measurement information based on the multipliers, panel audience measurement data, and the census audience measurement data, and reporter circuitry to generate a report including the first census audience measurement information and the second census audience measurement information.

### RELATED APPLICATION

This patent arises from a continuation of U.S. Patent Application No. 63/114,359, which was filed on Nov. 16, 2020. U.S. Patent Application No. 63/114,359 is hereby incorporated herein by reference in its entirety. Priority to U.S. Patent Application No. 63/114,359 is hereby claimed.

### FIELD OF THE DISCLOSURE

This disclosure relates generally to computer-based measurement and, more particularly, to methods and apparatus to determine census audience measurements.

### BACKGROUND

Media is accessible to users through a variety of platforms. For example, media can be viewed on television sets, via the Internet, on mobile devices, in-home or out-of-home, live or time-shifted, etc. Understanding consumer-based engagement with media within and across a variety of platforms (e.g., television, online, mobile, and emerging) allows media providers and website developers to increase user engagement with their media.

### BRIEF DESCRIPTION OF THE DRAWINGS

FIG. 1 illustrates an example environment in which duration values, impression count values, and audience size values are used to estimate census-level data for different demographics.

FIG. 2 is a block diagram of an example implementation of the audience metrics generator circuitry of FIG. 1.

FIG. 3 is an example audience metrics table (e.g., data table, output table) illustrating different data types available to the audience metrics generator circuitry.

FIG. 4A is an example audience metrics table showing example panel audience sizes, example panel impression counts, and example panel event durations for a first demographic index.

FIG. 4B is an example audience metrics table showing example panel audience sizes, example panel impression counts, and example panel event durations for a second demographic index.

FIG. 4C is an example audience metrics table showing example panel audience sizes, example panel impression counts, example panel event durations, example census impression counts, and example census event durations for a total across demographics.

FIG. 5A is an example audience metrics table showing the example panel audience sizes, the example panel impression counts, and the example panel event durations for the first demographic index of FIG. 4A and example census audience sizes, example census impression counts, and example census event durations for the first demographic index determined in accordance with teachings of this disclosure.

FIG. 5B is an example audience metrics table showing the example panel audience sizes, the example panel impression counts, and the example panel event durations for the second demographic index of FIG. 4B and example census audience sizes, example census impression counts, and example census event durations for the second demographic index determined in accordance with teachings of this disclosure.

FIG. 5C is an example audience metrics table showing the example panel audience sizes, the example panel impression counts, the example panel event durations, the example census impression counts, and the example census event durations for the total across demographics of FIG. 4C and example census audience sizes determined in accordance with teachings of this disclosure.

FIG. 6A is an example audience metrics table showing example panel audience sizes, example panel impression counts, and example panel event durations for a first demographic index.

FIG. 6B is an example audience metrics table showing example panel audience sizes, example panel impression counts, and example panel event durations for a second demographic index.

FIG. 6C is an example audience metrics table showing example panel audience sizes, example panel impression counts, and example panel event durations for a total across demographics.

FIG. 7A is an example audience metrics table showing the example panel audience sizes, the example panel impression counts, and the example panel event durations for the first demographic index of FIG. 6A and example census audience sizes, example census impression counts, and example census event durations for the first demographic index determined in accordance with teachings of this disclosure.

FIG. 7B is an example audience metrics table showing the example panel audience sizes, the example panel impression counts, and the example panel event durations for the second demographic index of FIG. 6B and example census audience sizes, example census impression counts, and example census event durations for the second demographic index determined in accordance with teachings of this disclosure.

FIG. 7C is an example audience metrics table showing the example panel audience sizes, the example panel impression counts, and the example panel event durations for the total across demographics of FIG. 6C and example census audience sizes, example census impression counts, and example census event durations determined in accordance with teachings of this disclosure.

FIGS. 8-12 are flowcharts representative of example machine readable instructions that may be executed by example processor circuitry to implement the example audience metrics generator circuitry of FIGS. 1 and/or 2 to determine census audience measurement information.

FIG. 13 is a block diagram of an example processing platform including processor circuitry structured to execute the example machine readable instructions of FIGS. 8-12 to implement the example audience metrics generator circuitry of FIGS. 1 and/or 2.

FIG. 14 is a block diagram of an example implementation of the processor circuitry of FIG. 13.

FIG. 15 is a block diagram of another example implementation of the processor circuitry of FIG. 13.

FIG. 16 is a block diagram of an example software distribution platform (e.g., one or more servers) to distribute software (e.g., software corresponding to the example machine readable instructions of FIGS. 8-12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Techniques for monitoring user access to Internet-accessible media, such as digital television (DTV) media and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server. Server logs cannot track such repeat views of cached media. Thus, server logs are susceptible to both over-counting and under-counting errors.

The techniques disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client requests the media, both the media and the monitoring instructions are downloaded to the client. The monitoring instructions are, thus, executed whenever the media is accessed, be it from a server or from a cache. Upon execution, the monitoring instructions cause the client to send or transmit monitoring information from the client to a content provider site. The monitoring information is indicative of the manner in which content was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietor s to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

Techniques disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. Techniques disclosed in Mazumdar accomplish this task by structuring the AME to respond to impression requests from clients (who may not be a member of an AME panel and, thus, may be unknown to the AME) by redirecting the clients from the AME to a database proprietor, such as a social network site partnered with the AME, using an impression response. Such a redirection initiates a communication session between the client accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client to thereby identify the client based on the internal records of the database proprietor. In the event the client device corresponds to a subscriber of the database proprietor, the database proprietor logs/records a database proprietor demographic impression in association with the user/client device.

As used herein, an impression is defined to be an event in which a home or individual accesses and/or is exposed to media (e.g., an advertisement, content, a group of advertisements and/or a collection of content). In Internet media delivery, a quantity of impressions or impression count is the total number of times media (e.g., content, an advertisement, or an advertisement campaign) has been accessed by a web population (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

A user of a computing device (e.g., a mobile device, a tablet, a laptop, etc.) and/or a television may be exposed to the same media via multiple devices (e.g., two or more of a mobile device, a tablet, a laptop, etc.) and/or via multiple media types (e.g., digital media available online, digital TV (DTV) media temporarily available online after broadcast, TV media, etc.). For example, a user may start watching a first television program on a television as part of TV media, pause the program, and continue to watch the program on a tablet as part of DTV media. In such an example, the exposure to the program may be logged by an AME twice, once for an impression log associated with the television exposure, and once for the impression request generated by a tag (e.g., census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., AME panelists or non-panelists) for which an audience measurement entity stores demographic information or can obtain demographic information. Deduplication is a process to adjust cross-platform media exposure totals by reducing (e.g., eliminating) the double counting of individual audience members that were exposed to media via more than one platform and/or are represented in more than one database of media impressions used to determine the reach of the media.

As used herein, unique audience members are audience members who are distinguishable from one another. Furthermore, a unique audience is made up of unique audience members. Moreover, a particular audience member exposed to particular media is measured as a single unique audience member regardless of how many times that audience member is exposed to that particular media or the particular platform(s) through which the audience member is exposed to the media. If that particular audience member is exposed multiple times to the same media, the multiple exposures for the particular audience member to the same media is counted as only a single unique audience member. In this manner, impression performance for particular media is not disproportionately represented when a small subset of one or more audience members is exposed to the same media an excessively large number of times while a larger number of audience members is exposed fewer times or not at all to that same media. By tracking exposures to unique audience members, a unique audience measure may be used to determine a reach measure to identify how many unique audience members are reached by media. In some examples, increasing the size of a unique audience and, thus, reach, is useful for advertisers wishing to reach a larger audience base.

Notably, although third-party cookies are useful for third-party measurement entities in many of the above-described techniques to track media accesses and to leverage demographic information from database proprietors, use of third-party cookies may be limited or may cease in some or all online markets. That is, use of third-party cookies enables sharing anonymous personally identifiable information (PII) across entities which can be used to identify and deduplicate audience members across database proprietor impression data. However, to reduce or eliminate the possibility of revealing user identities outside database proprietors by such anonymous data sharing across entities, some websites, internet domains, and/or web browsers may stop (or have already stopped) supporting third-party cookies. This hampering of third-party cookies will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data may not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

As used herein, census data corresponds to impressions (e.g., exposures to a media item by an audience member) logged for a general audience in a population regardless of whether the impressions correspond to audience members that are identifiable by the AME. In such examples, census-level impressions are collected as anonymous impression data. In many cases, AMEs may only have access to partial census-level data (e.g., a total census-level impression count across all demographics) but not access to complete census-level data (e.g., a census-level impression count for each individual demographic). In examples disclosed herein, to enrich the anonymous impression collected census data, a database proprietor collects demographic impression data by monitoring media accesses by its subscribers and logging corresponding impressions in association with demographic data collected from its subscribers. In examples disclosed herein, such demographic impression data corresponding to subscribers is also referred to as database proprietor (DP) panel data or DP panel impression data because it corresponds to known subscribers of the database proprietor which form a DP panel of audience members.

As used herein, a universe audience (e.g., a total audience, a unique audience, a deduplicated audience, a unique total audience, etc.) for media is a total number of persons that accessed the media in a particular geographic scope of interest and/or during a time of interest relating to media audience metrics. Determining if a larger unique audience is reached by certain media (e.g., an advertisement) can be used to identify if an AME client (e.g., an advertiser) is reaching a larger audience base. When an AME logs an impression for access to media by a user not associated with any demographic information, the logged impression counts as a census-level impression. As such, multiple census-level impressions can be logged for the same user since the user is not identified as a unique audience member. Estimation of census-level unique audience, impression counts (e.g., number of times a webpage has been viewed), and impression durations for individual demographics can increase the accuracy of usage statistics provided by monitoring entities such as AMEs.

In the context of audience measurements for Internet-based media providers such as YouTube®, an audience measurement entity may have census-level information reflecting the total impressions (e.g., access to media, impression count values, impression requests, impression data etc.) and duration (e.g., duration values, duration data, impression duration values) of such impressions, but lack unique total audience (e.g., unique total audience size, unique total audience size values) and how the unique total audience, total impressions (e.g., accesses to media such as content, advertisements, webpage (pageviews), etc.) and durations are distributed across demographics. However, database proprietor data provides partial information on unique total audience sizes, total impression counts, and durations based on media access activities of subscribers of the database proprietor. Examples disclosed herein use such database proprietor information to estimate individual demographic level audience size (e.g., unique audience size for a specific demographic), individual demographic level impression counts, and individual demographic level durations of such impressions on the census data.

In examples disclosed herein, census constraints can be given to the AME. Example census constraints include a first constraint equation or set of constraint equations (e.g., the total impressions are to match the sum of the impressions for each demographic) and a second constraint equation or set of constraint equations (e.g., the total duration of such impressions is to match the sum of the impression duration for each demographic). In examples disclosed herein, an AME defines Lagrange multipliers for each of the constraint equations and determines bounds for the Lagrange multipliers. In examples disclosed herein, the example AME solves for the Lagrange multipliers within the bounds to determine estimates for demographic level census data. In addition, the estimates are logically consistent with all constraints and the procedure is a good (e.g., optimal) solution with regards to Information Theory. Examples disclosed herein described as determining some metric or measurement (e.g., an audience size, an impression count, a duration) for each demographic and/or dimension refers to determining the metric or measurement for an individual demographic and/or individual dimension (e.g., a media item) such that an audience size, an impression count, and/or a duration corresponds to a single demographic group and/or a single dimension (e.g., a media item).

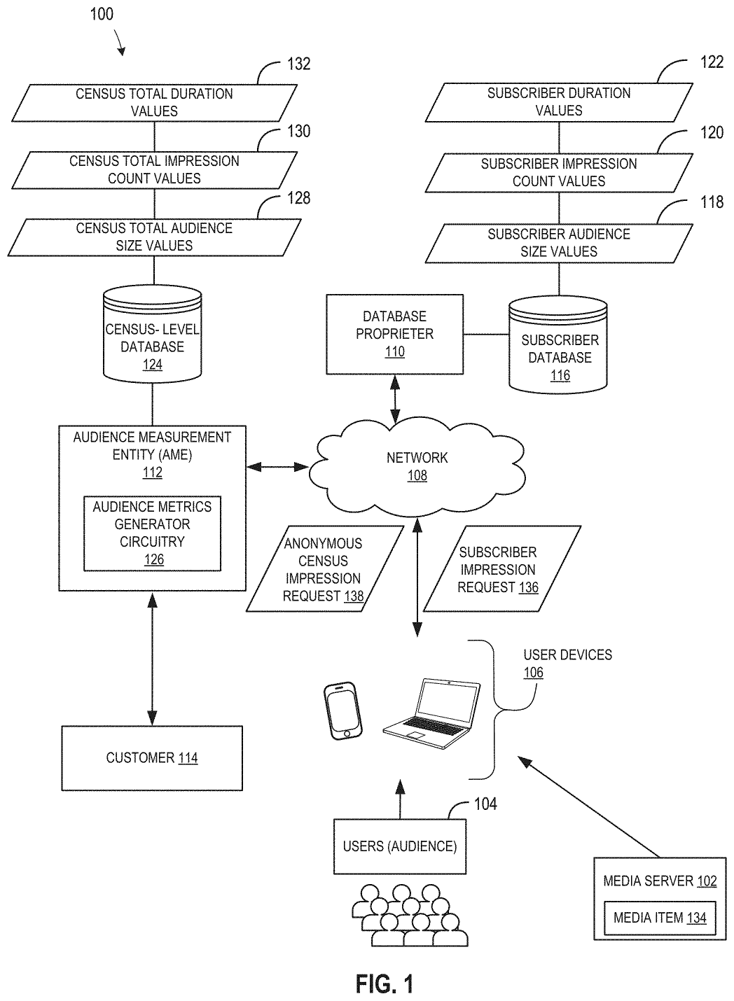

FIG. 1 is a block diagram illustrating an example environment 100 in which example audience metrics generator circuitry 126 is implemented to determine audience metrics or audience measurements such as census-level audience sizes, impression counts, and impression durations across demographics, wherein the census-level estimates are accurate for ones of the different demographics and are accurate across the different demographics. As used herein, audience metrics, audience measurement information, and audience measurement data are used to refer to collected and/or generated data representing audience size, impression count and/or duration. As such, census audience metrics, census audience measurement information, and/or census audience measurement data may be used to refer to census audience size, census impression count, and/or census duration. In addition, panel audience metrics, panel audience measurement information, and/or panel audience measurement data may be used to refer to panel audience size, panel impression count, and/or panel duration.

The example operating environment 100 of FIG. 1 includes an example media server 102, example users 104 (e.g., an audience), example user devices 106, an example network 108, an example database proprietor 110, an example audience measurement entity (AME) 112 and an example customer 114. The database proprietor 110 includes an example subscriber database 116. The subscriber database 116 includes example subscriber audience size data 118 (e.g., subscriber audience size data, subscriber unique total audience size values, subscriber unique audience size values for each demographic), example subscriber impression count values 120 (e.g., subscriber impression data, subscriber impression count data, subscriber total impression count values, subscriber impression count values for each demographic), and example subscriber duration values 122 (e.g., subscriber impression duration data, subscriber total impression duration, subscriber impression duration for each demographic). The AME 112 includes an example census-level database 124 and an example audience metrics generator circuitry 126. The census-level database 124 includes example census total audience size values 128 (e.g., census unique total audience size data), census total impression count values 130 (e.g., census total impressions, census total impression counts) and example census total duration values 132 (e.g., census total duration data, census total durations, census total impression duration values). In the example of FIG. 1, the users 104 access the same media item 134 from the media server 102 on respective user devices 106. The impression requests are logged as either a subscriber impression request 136 (e.g., a request from a known user) or an anonymous census impression request 138 (e.g., census-level impression request, census impression request, anonymous impression request).

In the illustrated example, the example media server 102 serves the media 134 (e.g., media item 134) to the user devices 106 (e.g., client devices). As used herein, “media” refers collectively and/or individually to content and/or advertisement(s). For example, the media server 102 may serve one or more of different types of media (e.g., movies, songs, advertisements, webpages, e-books, etc. in the form of any one or more of video, audio, images, text, etc.).

Example users 104 include any individuals who access media on one or more user device(s) 106, such that the occurrence of access and/or exposure to media creates a media impression (e.g., viewing of an advertisement, a movie, a webpage banner, a webpage, etc.). A subset of example users 104 are panelists that have provided their demographic information when registering with the example AME 112. When the example users 104 who are panelists utilize example user devices 106 to access media through the example network 108, the AME 112 (e.g., AME servers) stores panelist activity data associated with their demographic information. The example users 104 also include individuals who are not panelists (e.g., not registered with the AME 112). The example users 104 include individuals who are subscribers to services provided by the database proprietor 110 and utilize these services via their user device(s) 106.

Example user devices 106 (e.g., client devices 106) can be stationary or portable computers, handheld computing devices, smart phones, Internet appliances, and/or any other type of device that may be capable of accessing media over a network (e.g., the Internet, network 108). In the illustrated example of FIG. 1, the user devices 106 include a smartphone (e.g., an Apple® iPhone®, a Motorola™ Moto X™, a Nexus 5, an Android™ platform device, etc.) and a laptop computer. However, any other type(s) of device(s) may additionally or alternatively be used such as, for example, a tablet (e.g., an Apple® iPad™, a Motorola™ Xoom™, etc.), a desktop computer, a camera, an Internet compatible television, a smart TV, etc. Examples disclosed herein may be used to collect impression information for any type of media including content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as a YouTube® website, and subsequently downloaded and/or streamed by one or more other client devices for playback. Media may also include advertisements. Advertisements are typically distributed with content (e.g., programming, on-demand video and/or audio). Traditionally, content is provided at little or no cost to the audience because it is subsidized by advertisers that pay to have their advertisements distributed with the content. The user devices 106 of FIG. 1 are used to access (e.g., request, receive, render and/or present) online media provided, for example, by a web server. For example, users 104 can execute a web browser on the user devices 106 to request streaming media (e.g., via an HTTP request) from a media hosting server. The web server can be any web browser used to provide media (e.g., a YouTube® website) that is accessed, through the example network 108, by the example users 104 on example user device(s) 106.

The example network 108 is a communications network that may be implemented using any suitable wired and/or wireless network(s) including, for example, one or more data buses, one or more Local Area Networks (LANs), one or more wireless LANs, wide area network, a cloud, one or more cellular networks, the Internet, etc. As used herein, the phrase “in communication,” including variances thereof, encompasses direct communication and/or indirect communication through one or more intermediary components and does not require direct physical (e.g., wired) communication and/or constant communication, but rather additionally includes selective communication at periodic or aperiodic intervals, as well as one-time events. The example network 108 allows example impression requests from the example user devices 106 to be stored by the example database proprietor 110 and audience measurement entity 112. In some examples, the user devices 106 communicate with the example network 108 via the Internet.

In some examples, media (also referred to as a media item 134) is tagged or encoded to include monitoring or tag instructions. The monitoring instructions are computer executable instructions (e.g., Java or any other computer language or script) executed by web browsers accessing media content (e.g., via network 108). Execution of monitoring instructions causes the web browser to send an impression request (e.g., anonymous census impression request 138, subscriber impression request 136, etc.) to the servers of the AME 112 and/or the database proprietor 110. Demographic impressions are logged by the database proprietor 110 when user devices 106 accessing media are identified as belonging to registered subscribers of the database proprietor 110. The example database proprietor 110 stores data generated for registered subscribers in the subscriber database 116. Likewise, the example AME 112 logs census-level media impressions (e.g., census-level impressions, anonymous impression requests) for user devices 106, regardless of whether demographic information is available for such logged impressions. The example AME 112 stores census-level data information in the census-level data storage 124 (e.g., census-level database 124). Further examples of monitoring instructions and methods of collecting impression data are disclosed in U.S. Pat. No. 8,370,489 entitled “Methods and Apparatus to Determine Impressions using Distributed Demographic Information,” U.S. Pat. No. 8,930,701 entitled “Methods and Apparatus to Collect Distributed User Information for Media Impressions and Search Terms,” and U.S. Pat. No. 9,237,138 entitled “Methods and Apparatus to Collect Distributed User Information for Media Impressions and Search Terms,” all of which are hereby incorporated herein by reference in their entireties. In the example of FIG. 1, the users 104 access the same media item 134 from the media server 102 on respective user devices 106. The impression requests are logged as either a subscriber impression request 136 or an anonymous census impression request 138.

The example AME 112 operates as an independent party to measure and/or verify audience measurement information relating to media accessed by users, for example, subscribers of the database proprietor 110. When media is accessed by user devices 106, the example AME 112 stores census-level information (e.g., the anonymous census impression requests 138) in the census-level database 124, including census total impression count values 130 (e.g., number of webpage views), and census total duration values 132 (e.g., length of time that a webpage was viewed). In some examples, the AME 112 stores census total audience size values 128 in addition to census total impression count values 130 and census total duration values 132. The example database proprietor 110 provides the AME 112 with aggregate subscriber data that obfuscates the person-specific data, such that reference aggregates among the individuals within a demographic are available (e.g., aggregate subscriber-based audience metrics). For example, the subscriber audience size values 118, the subscriber impression count values 120, and subscriber duration values 122 are provided at a demographic level (e.g., females 18-25, males 18-25, females 26-35, males 26-35, etc.). For example, the subscriber audience size values 118 correspond to unique audience size data in the aggregate per demographic category.

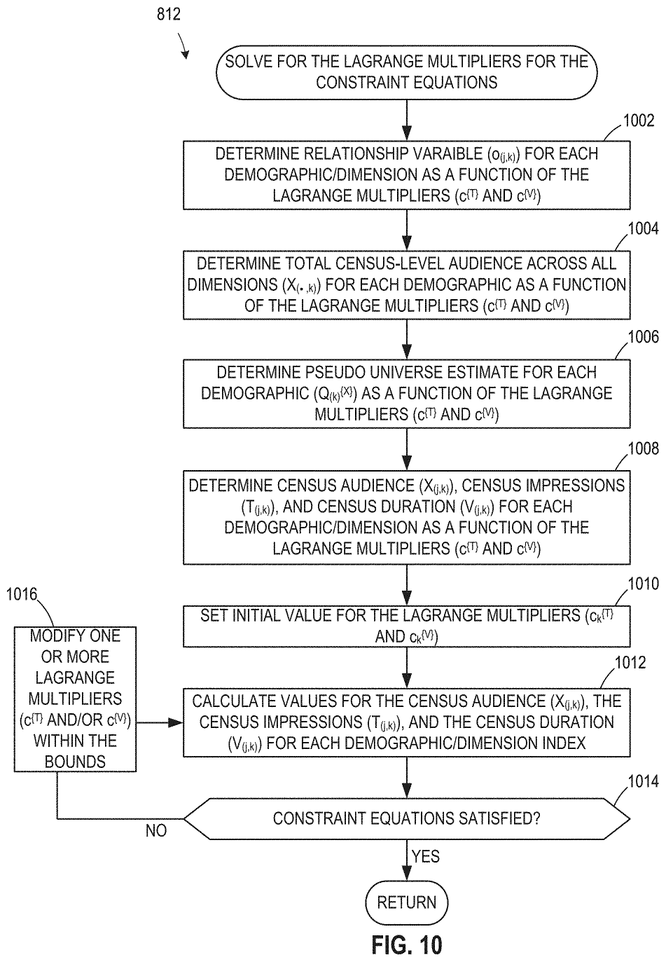

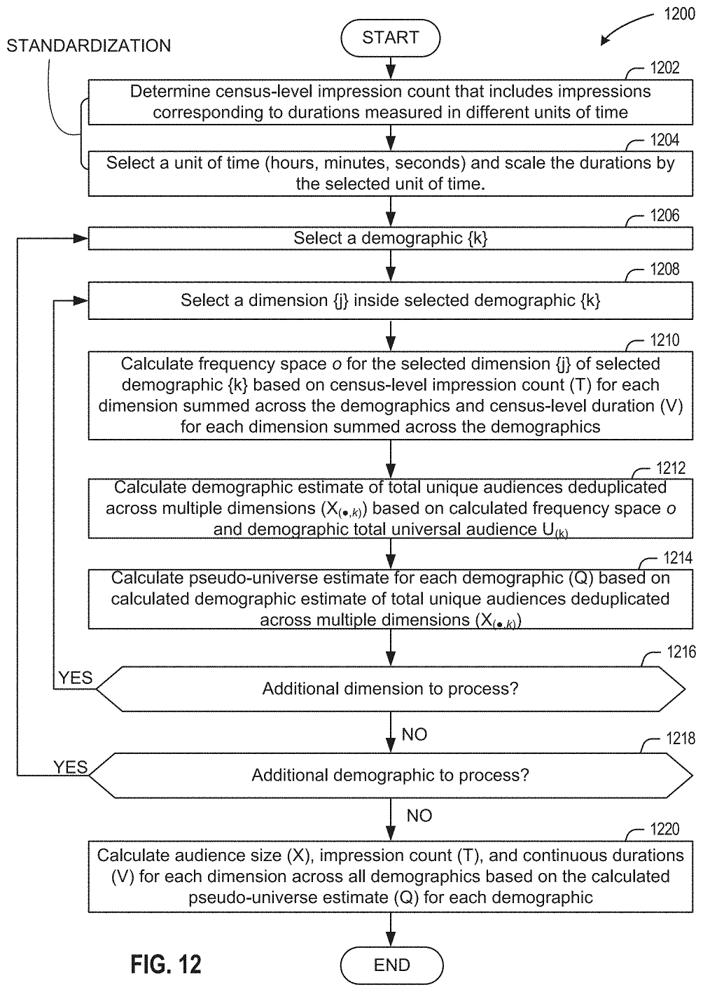

The example audience metrics generator circuitry 126 of the AME 112 receives aggregate subscriber-based audience metrics data (e.g., subscriber audience size values 118, subscriber impression count values 120, and subscriber duration values 122). The example audience metrics generator circuitry 126 uses the aggregate data to determine census-level audience size data, census-level impression counts data, and census-level impression duration data for individual demographics. In addition, the example audience metrics generator circuitry 126 uses the census-level data available to the AME 112 (e.g., census total audience size values 128, census total impression count values 130 and census total duration values 132) to generate the census-level audience, impressions, and duration estimates for the subscriber-based data for individual demographics. The example AME 112 may output the census-level audience size data, census-level impression count data, and census-level impression duration data for individual demographics to an example customer 114. For example, the AME 112 may send the audience metrics to the example customer 114 as a table or a report. Examples of audience metrics tables that may be sent to the example customer 114 are further described in conjunction with FIGS. 10A, 10B, 10C, 12A, 12B, and 12C.

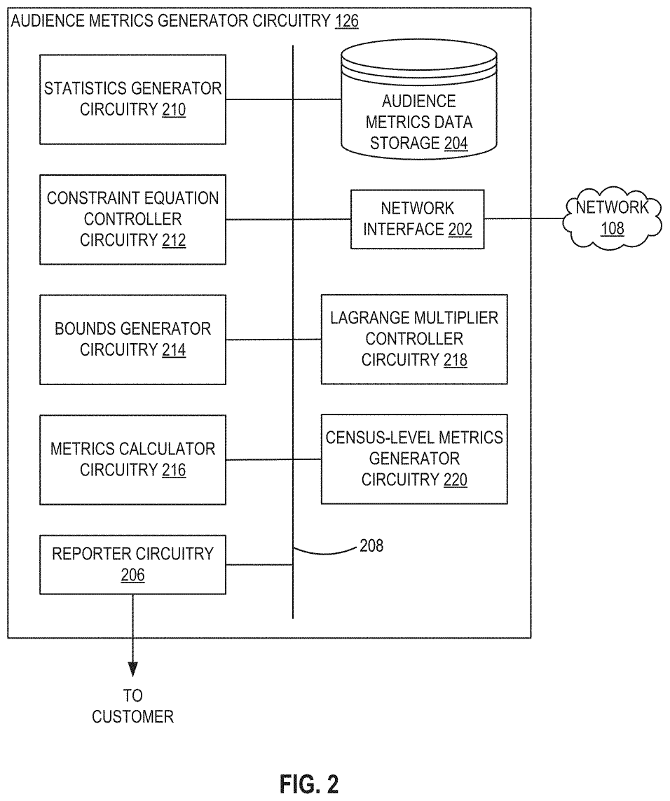

FIG. 2 is a block diagram of an example implementation of the audience metrics generator circuitry 126 of FIG. 1. The example audience metrics generator circuitry 126 includes an example network interface 202, an example audience metrics data storage 204, and example reporter circuitry 206, all of which are in communication (e.g., by exchanging data via accessing, requesting, and/or loading) via an example bus 208. The example audience metrics generator circuitry 126 determines census audience metrics including census audience sizes, census total impression counts, and census total durations for a plurality of demographic groups for a plurality of media items (e.g., dimensions). As such, the example audience metrics generator circuitry 126 includes statistics generator circuitry 210, constraint equation controller circuitry 212, bounds generator circuitry 214, metrics calculator circuitry 216, Lagrange multiplier controller circuitry 218, and census-level metrics generator circuitry 220.

The example audience metrics generator circuitry 126 is provided with the example network interface 202 to communicate with the example network 108. In this manner, the example audience metrics generator circuitry 126 can use the network interface 202 to access subscriber audience metrics data (e.g., the subscriber audience size values 118, the subscriber impression count values 120, and/or the subscriber duration values 122 of FIG. 1) from the database proprietor 110 via the network 108. In some examples, the example network interface 202 additionally or alternatively enables the audience metrics generator circuitry 126 to communicate with the customer 114.

The example audience metrics data storage 204 (e.g., data store, audience metrics data store) stores aggregate subscriber-based audience metrics data accessed from the database proprietor 110. For example, data accessed from the database proprietor 110 can include the subscriber data (e.g., the subscriber audience size values 118, the subscriber impression count values 120, and/or the subscriber duration values 122 of FIG. 1). The example audience metrics data storage 204 can also store the census-level data (e.g., the census total audience size values 128, the census total impression count values 130 and/or the census total duration values 132 of FIG. 1. The audience metrics generator circuitry 126 accesses the subscriber-based data and census-level data from the audience metrics data storage 204 to perform census-level estimation calculations (e.g., determine census-level unique audience sizes, census-level unique impression counts, and census-level durations for given demographics). The audience metrics data storage 204 may be implemented by any storage device and/or storage disc for storing data such as, for example, flash memory, magnetic media, optical media, etc. Furthermore, the data stored in the audience metrics data storage 204 may be in any data format such as binary data, comma delimited data, tab delimited data, structured query language (SQL) structures, etc. While in the illustrated example the audience metrics data storage 204 is illustrated as a single database, the audience metrics data storage 204 can be implemented by any number and/or type(s) of databases.

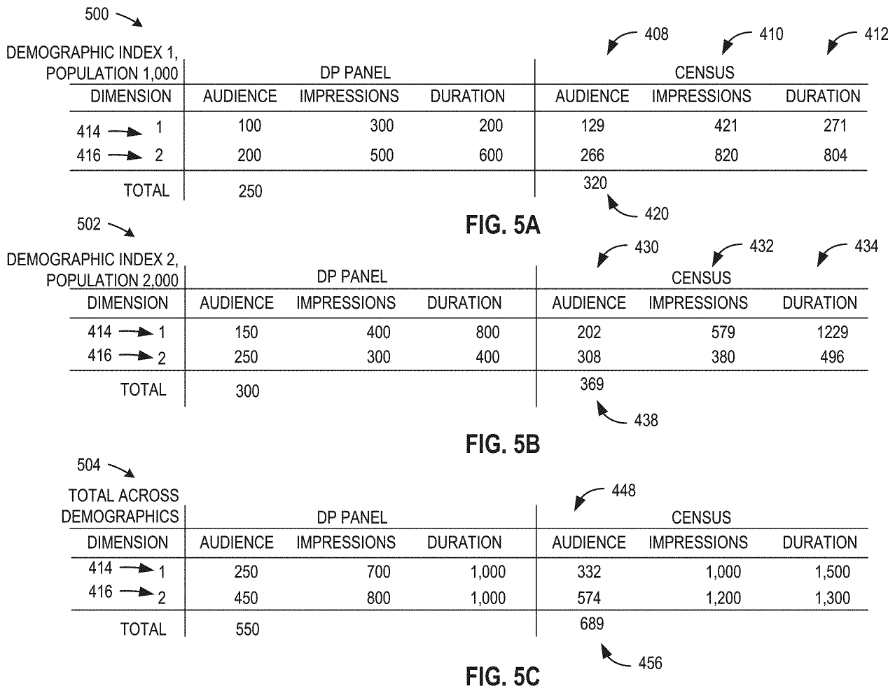

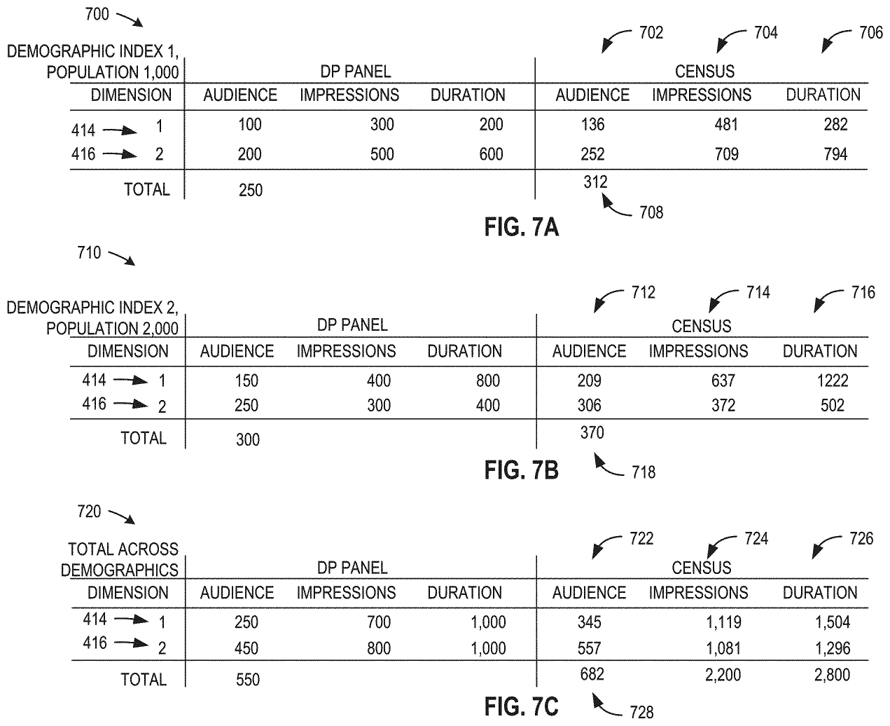

The example reporter circuitry 206 outputs the census-level demographic results determined by the audience metrics generator circuitry 126. For example, the reporter circuitry 206 may send the census-level demographic results to a customer (e.g., the customer 114 of FIG. 1). Examples of audience metrics tables that may be sent to the example customer 114 are further described in conjunction with FIGS. 5A, 5B, 5C, 7A, 7B, and 7C.

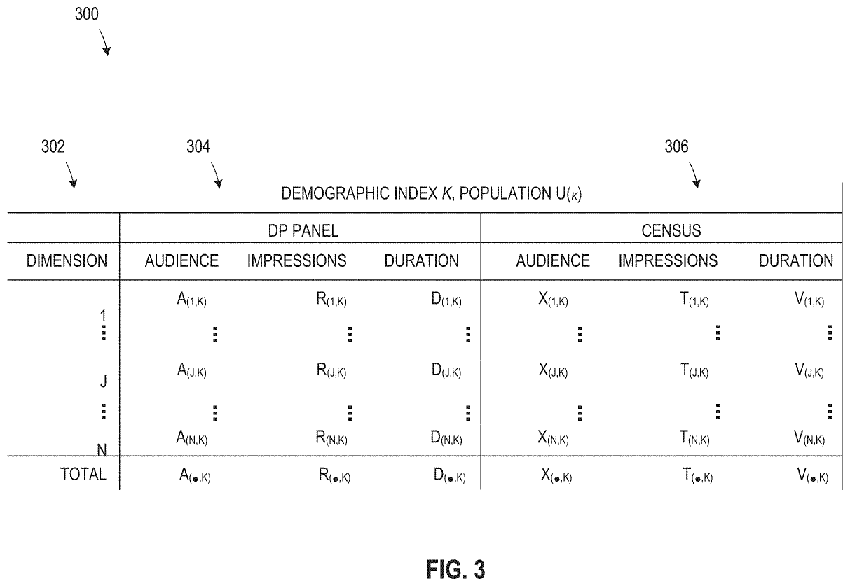

As discussed further below in connection with FIG. 3, the audience metrics including the subscriber data and the census-level data includes metrics for a plurality of media items (e.g., dimensions) (j) for a plurality of demographics. For each demographic index (k), there is known information including a population for the demographic index (U₍ₖ₎), panel audience data for each dimension (A_{(j,k)}), panel impression count for each dimension (R_{(j,k)}), panel duration data for each dimension (D_{(j,k)}), a deduplicated total panel audience (A_{(•,k)}), a total panel impression count (R_{(•,k)}), and a total panel duration data (D_{(•,k)}). In some examples, a census impression count for each dimension across all demographics (T_{(j,•)}) and census duration data for each dimension across all demographics (V_{(j,•)}) are known. In these examples, when a user/client device (e.g., the user devices 106 of FIG. 1) accesses media (e.g., the media item 134 of FIG. 1), the anonymous census impression request 138 (FIG. 1) sent to the AME 112 (FIG. 1) includes the dimension corresponding to the impression request. Thus, the census-level database 124 (FIG. 1) includes anonymous (e.g., non-demographic) census-level audience measurement data including dimension information. In other examples, only total census impression count across all dimensions and all demographics (T_{(•,•)}) and total census duration data across all dimensions and all demographics (V_{(•,•)}) are known. In these examples, when a user/client device (e.g., the user devices 106 of FIG. 1) accesses media (e.g., the media item 134 of FIG. 1), the anonymous census impression request 138 (FIG. 1) sent to the AME 112 (FIG. 1) does not include dimension information. Thus, the census-level database 124 (FIG. 1) only includes anonymous (e.g., non-demographic) census-level audience measurement data aggregated across all dimensions and demographics.

The total panel impression count (R_{(•,k)}) and the a total panel duration data (D_{(•,k)}) are simple summations of the panel impression counts for each dimension and the panel duration data for each dimension, respectively. However, the deduplicated total panel audience (A_{(•,k)}) is not a simple summation as multiple people can appear within multiple dimensions and the deduplicated total panel audience (A_{(•,k)}) is a unique audience without double counting any individual. Thus, the total audience, impression count, and duration data can be expressed using the below Equations 1a, 1b, and 1c.

$$\begin{matrix}{max}_{j} ( {A}_{( j , k )} ) \leq {A}_{( \cdot , k )} \leq {\sum }_{j = 1}^{n} {A}_{( j , k )} & ( Equation 1 a ) \\ {R}_{( \cdot , k )} = {\sum }_{j = 1}^{n} {R}_{( j , k )} & ( Equation 1 b ) \\ {D}_{( \cdot , k )} = {\sum }_{j = 1}^{n} {D}_{( j , k )} & ( Equation 1 c )\end{matrix}$$

Similar equations to Equations 1a-1c can be generated for census audience data, census impression counts, and census duration data. Additionally, below Equations 2a and 2b represent expressions corresponding to census impression count for each dimension across all demographics (T_{(j,•)}) and total census impression count across all dimensions and all demographics (T_{(•,•)}).

$$\begin{matrix}{T}_{( j , \cdot )} = {\sum }_{k = 1}^{K} {T}_{( j , k )} & ( Equation 2 a ) \\ {T}_{( \cdot , \cdot )} = {\sum }_{k = 1}^{K} {T}_{( \cdot , k )} = {\sum }_{j = 1}^{n} {T}_{( j , \cdot )} = {\sum }_{j = 1}^{n} {\sum }_{k = 1}^{K} {T}_{( j , k )} & ( Equation 2 b )\end{matrix}$$

Additionally, the audience metrics data can include deduplicated total panel audience across all demographics and dimensions (A_{(•,•)}) which can be defined using the below Equations 3a and 3b.

$$\begin{matrix}{A}_{( j , \cdot )} = {\sum }_{k = 1}^{K} {A}_{( j , k )} & ( Equation 3 a ) \\ {A}_{( \cdot , \cdot )} = {\sum }_{k = 1}^{K} {A}_{( \cdot , k )} \leq {\sum }_{j = 1}^{n} {A}_{( j , \cdot )} = {\sum }_{j = 1}^{n} {\sum }_{k = 1}^{K} {A}_{( j , k )} & ( Equation 3 b )\end{matrix}$$

The example audience metrics generator circuitry 126 includes the statistics generator circuitry 210 to determine statistics corresponding to the subscriber data including pseudo-universe estimates for each demographic and constraint variables. Techniques disclosed in Sheppard et al., U.S. patent application Ser. No. 17/408,164, which is incorporated by reference herein in its entirety, solve a maximum entropy problem for a single demographic case. The solution for the maximum entropy problem for the single demographic case disclosed in Sheppard is shown in below Equations 4a, 4b, 4c, 4d, 4e, and 5.

$$\begin{matrix}{z}_{j}^{( a )} = \frac{{A}_{j}^{3}}{( Q - {A}_{j} ) ( {R}_{j} - {A}_{j} ) {D}_{j}} j = \{ 1 , 2 , … , n \} & ( Equation 4 a ) \\ {z}_{j}^{( i )} = 1 - \frac{{A}_{j}}{{R}_{j}} j = \{ 1 , 2 , … , n \} & ( Equation 4 b ) \\ {z}_{j}^{( d )} = exp ( - \frac{{A}_{j}}{{D}_{j}} ) j = \{ 1 , 2 , … , n \} & ( Equation 4 c ) \\ {z}_{\cdot } = \frac{Q - {A}_{\cdot }}{U - {A}_{\cdot }} & ( Equation 4 d ) \\ {z}_{0} = U - {A}_{\cdot } & ( Equation 4 e ) \\ 1 - \frac{{A}_{\cdot }}{Q} = {\prod }_{j = 1}^{n} ( 1 - \frac{{A}_{j}}{Q} ) & ( Equation 5 )\end{matrix}$$

In examples disclosed herein, multiple demographics are included in the audience metrics data. As such, the above Equations 4a-4e and 5 can be updated to include the K demographics. Additionally, each demographic includes two pseudo-universe estimates, a pseudo-universe estimate for the panel (Q₍ₖ₎^{{A}}) and a pseudo-universe estimate for the census (Q₍ₖ₎^{{X}}). The change in notation results in the below Equations 6a, 6b, 6c, 6d, 6e, and 7. Equations 6a-7 are true for all j={1, 2, . . . n} and k={1, 2, . . . K}. A similar equation to Equation 7 can be generated for the census audience, X, by substituting Q₍ₖ₎^{{A}} for Q₍ₖ₎^{{X}} and A for X.

$$\begin{matrix}{z}_{( j , k )}^{\{ a \}} = \frac{{A}_{( j , k )}^{3}}{( {Q}_{( k )}^{\{ A \}} - {A}_{( j , k )} ) ( {R}_{{ }^{( j , k )}} - {A}_{( j , k )} ) {D}_{( j , k )}} & ( Equation 6 a ) \\ {z}_{( j , k )}^{\{ i \}} = 1 - \frac{{A}_{( j , k )}}{{R}_{( j , k )}} & ( Equation 6 b ) \\ {z}_{( j , k )}^{\{ d \}} = exp ( - \frac{{A}_{( j , k )}}{{D}_{( j , k )}} ) & ( Equation 6 c ) \\ {z}_{( k )}^{\{ \cdot \}} = \frac{{Q}_{( k )}^{\{ A \}} - {A}_{( \cdot , k )}}{{U}_{( k )} - {A}_{( \cdot , k )}} & ( Equation 6 d ) \\ {z}_{( k )}^{\{ 0 \}} = {U}_{( k )} - {A}_{( \cdot , k )} & ( Equation 6 e ) \\ 1 - \frac{{A}_{( \cdot , k )}}{{Q}_{( k )}^{\{ A \}}} = {\prod }_{j = 1}^{n} ( 1 - \frac{{A}_{( j , k )}}{{Q}_{( k )}^{\{ A \}}} ) & ( Equation 7 )\end{matrix}$$

The example statistics generator circuitry 210 of FIG. 2 determines summary statistics for the panel audience metrics data. For example, the statistics generator circuitry 210 can use Equations 6a, 6b, 6c, 6d, 6e, and 7 to determine constraint variables z_{(j,k)}^{{a}}, z_{(j,k)}^{{i}}, and z_{(j,k)}^{{d}} for each demographic and dimension index, constraint variables z₍ₖ₎^{{•}} and z₍ₖ₎^{{0}} for each demographic, and the pseudo-universe estimate for each demographic (Q₍ₖ₎^{{A}}).

In examples disclosed herein, determining the census audience metrics data can be simplified by constraining the census impression counts and the census duration data to known total census impression counts and known total census duration data. For example, for a given dimension (j), total census impression counts (T_{(j,•)}) may be known, but the distribution of the impression counts across the demographics may be unknown. Additionally, for a given dimension (j), total census duration data (V_{(j,•)}) may be known, but the distribution of the duration data across the demographics may be unknown. The impression constraint equation is represented below by example Equation 8a and the duration constraint equation is represented below by example Equation 8b. Examples disclosed herein determine census audience data, census impression counts, and census duration data for each dimension and each demographic subject to the constraints of Equations 8a and 8b. In some examples, only total census impression counts and total census duration data across the demographics and the dimensions are known. In these examples, the constraints of Equations 9a and 9b can be used. In the example of using Equations 8a and 8b to set constraint equations, the number of constraint equations is 2*n wherein n is the number of dimensions. In the example of using Equations 9a and 9b to set constraint equations, the number of constraint equations is two.

$$\begin{matrix}{T}_{( j , \cdot )} = {\sum }_{k = 1}^{K} {T}_{( j , k )} \\ j = \{ 1 , 2 , … , n \} & ( Equation 8 a ) \\ {V}_{( j , \cdot )} = {\sum }_{k = 1}^{K} {V}_{( j , k )} \\ j = \{ 1 , 2 , … , n \} & ( Equation 8 b ) \\ {T}_{( \cdot , \cdot )} = {\sum }_{j = 1}^{n} {\sum }_{k = 1}^{K} {T}_{( j , k )} & ( Equation 9 a ) \\ {V}_{( \cdot , \cdot )} = {\sum }_{j = 1}^{n} {\sum }_{k = 1}^{K} {V}_{( j , k )} & ( Equation 9 a )\end{matrix}$$

The example constraint equation controller circuitry 212 selects the constraint equations for solving for census audience metrics data. For example, the constraint equation controller circuitry 212 can use Equations 8a and 8b to select the 2*n constraint equations if total census impression counts and total census duration data are known for each dimension across all demographics. In other example, if total census impression counts and total census duration data are only known across all dimensions, across all demographics, the constraint equation controller circuitry 212 can use Equations 9a an 9b to select the two constraint equations.

In examples disclosed herein, each constraint defined by a constraint equation of Equations 8a, 8b, 9a, and/or 9b has a corresponding Lagrange multiplier. In the example of using the 2*n constraint equations determined using Equations 8a and 8b, there are 2*n Lagrange multipliers. A quantity of n Lagrange multipliers (λ₍ⱼ₎^{{T}}) corresponding to the census impression counts for each dimension and a quantity of n Lagrange multipliers (λ₍ⱼ₎^{{V}}) corresponding to the census duration data for each dimension. For each demographic (e.g., demographic index k), the following equations 10a, 10b, 10c, 10d, and 11 can be defined.

$$\begin{matrix}log ( \frac{{( {X}_{( j , k )} )}^{3}}{( {Q}_{( k )}^{\{ X \}} - {X}_{( j , k )} ) ( {T}_{( j , k )} - {X}_{( j , k )} ) {V}_{( j , k )}} ) - log ( z \begin{matrix}\{ a , Q \} \\ ( j , k )\end{matrix} ) = 0 & ( Eq . 10 a ) \\ log ( 1 - \frac{{X}_{( j , k )}}{{T}_{( j , k )}} ) - log ( z \begin{matrix}\{ i , Q \} \\ ( j , k )\end{matrix} ) = {λ}_{( j )}^{\{ T \}} & ( Eq . 10 b ) \\ log ( exp ( - \frac{{X}_{( j , k )}}{{V}_{( j , k )}} ) ) - log ( z \begin{matrix}\{ d , Q \} \\ ( j , k )\end{matrix} ) = {λ}_{( j )}^{\{ V \}} & ( Eq . 10 c ) \\ log ( \frac{{Q}_{( k )}^{\{ X \}} - {X}_{( \cdot , k )}}{{U}_{( k )} - {X}_{( \cdot , k )}} ) - log ( z \begin{matrix}\{ \cdot , Q \} \\ ( k )\end{matrix} ) = 0 & ( Eq . 10 d ) \\ 1 - \frac{{X}_{( \cdot , k )}}{{Q}_{( k )}^{\{ X \}}} = {\prod }_{j = 1}^{n} ( 1 - \frac{{X}_{( j , k )}}{{Q}_{( k )}^{\{ X \}}} ) & ( Eq . 11 )\end{matrix}$$

Additionally, examples disclosed herein define multiplier variables c₍ⱼ₎^{{T}} and c₍ⱼ₎^{{V}} using the below example Equations 12a and 12b.

$$\begin{matrix}{c}_{( j )}^{\{ T \}} = exp ( {λ}_{( j )}^{\{ T \}} ) & ( Equation 12 a ) \\ {c}_{( j )}^{\{ V \}} = {λ}_{( j )}^{\{ V \}} & ( Equation 12 b )\end{matrix}$$

Given the definitions for the multiplier variables in Equations 12a and 12b, the solution to X_{(j,k)} is the output of the below example Equations 13a, 13b, 13c, and 13d. Further, the invariance of z can be defined by example Equation 14 below.

$$\begin{matrix}{f}_{( j , k )}^{\{ T \}} = {( 1 - {c}_{( j )}^{\{ T \}} {z}_{( j , k )}^{\{ i , Q \}} )}^{- 1} & ( Equation 13 a ) \\ {f}_{( j , k )}^{\{ y \}} = - {( {c}_{( j )}^{\{ V \}} + log ( {z}_{( j , k )}^{\{ d , Q \}} ) )}^{- 1} & ( Equation 13 b ) \\ {o}_{( j , k )} = ( {z}_{( j , k )}^{\{ a , Q \}} ) ( {f}_{( j , k )}^{\{ T \}} - 1 ) {f}_{( j , k )}^{\{ V \}} & ( Equation 13 c ) \\ {X}_{( j , k )} = ( \frac{{o}_{( j , k )}}{1 + {o}_{( j , k )}} ) {Q}_{( k )}^{\{ X \}} & ( Equation 13 d ) \\ \frac{{Q}_{( k )}^{\{ X \}} - {X}_{( \cdot , k )}}{{U}_{( k )} - {X}_{( \cdot , k )}} = {z}_{( k )}^{\{ \cdot , Q \}} & ( Equation 14 )\end{matrix}$$

As such, example Equation 11 defining Q₍ₖ₎^{{K}} can be rephrased as shown in example Equations 15a, 15b, and 15c below.

$$\begin{matrix}1 - \frac{{X}_{( \cdot , k )}}{{Q}_{( k )}^{\{ X \}}} = {\prod }_{j = 1}^{n} ( 1 - \frac{{o}_{( j , k )}}{1 + {o}_{( j , k )}} ) & ( Equation 15 a ) \\ 1 - \frac{{X}_{( \cdot , k )}}{{Q}_{( k )}^{\{ X \}}} = {\prod }_{j = 1}^{n} ( \frac{1}{1 + {o}_{( j , k )}} ) & ( Equation 15 b ) \\ 1 - \frac{{X}_{( \cdot , k )}}{{Q}_{( k )}^{\{ X \}}} = \frac{1}{{Π}_{j = 1}^{n} ( 1 + {o}_{( j , k )} )} & ( Equation 15 b )\end{matrix}$$

Defining P₍ₖ₎ using example Equation 16 below, example Equations 11 and 14 can be written as example Equations 17a and 17b below.

$$\begin{matrix}{P}_{( k )} = {\prod }_{j = 1}^{n} ( 1 + {o}_{( j , k )} ) & ( Equation 16 ) \\ \frac{{Q}_{( k )}^{\{ X \}}}{{Q}_{( k )}^{\{ X \}} - {X}_{( \cdot , k )}} = {P}_{( k )} & ( Equation 17 a ) \\ \frac{{Q}_{( k )}^{\{ X \}} - {X}_{( \cdot , k )}}{{U}_{( k )} - {X}_{( \cdot , k )}} = {z}_{( k )}^{\{ \cdot , Q \}} & ( Equation 17 b )\end{matrix}$$

The example Equations 17a and 17b above can be re-arranged to example Equations 18a and 18b below. By defining o_{(•,k)} using example Equation 19 below, the example Equations 18a and 18b can be simplified to example Equations 20a and 20b below.

$$\begin{matrix}{X}_{( \cdot , k )} = ( \frac{( {P}_{( k )} - 1 ) {z}_{( k )}^{\{ \cdot , Q \}}}{1 + ( {P}_{( k )} - 1 ) {z}_{( k )}^{\{ \cdot , Q \}}} ) {U}_{( k )} & ( Equation 18 a ) \\ {Q}_{( k )}^{\{ X \}} = ( \frac{{P}_{( k )} {z}_{( k )}^{\{ \cdot , Q \}}}{1 + ( {P}_{( k )} - 1 ) {z}_{( k )}^{\{ \cdot , Q \}}} ) {U}_{( k )} & ( Equation 18 b ) \\ {o}_{( \cdot , k )} = ( {P}_{( k )} - 1 ) {z}_{( k )}^{\{ \cdot , Q \}} & ( Equation 19 ) \\ {X}_{( \cdot , k )} = ( \frac{{o}_{( \cdot , k )}}{1 + {o}_{( \cdot , k )}} ) {U}_{( k )} & ( Equation 20 a ) \\ {Q}_{( k )}^{\{ X \}} = ( \frac{{P}_{( k )}}{{P}_{( k )} - 1} ) {X}_{( \cdot , k )} & ( Equation 20 b )\end{matrix}$$

Finally, solving for the pseudo-universe estimate for the census audience for each demographic (Q₍ₖ₎^{{X}}) allows solving for the audience size, impression count, and duration for each dimension within the demographic using below example Equations 21a, 21b, and 21c.

$$\begin{matrix}{X}_{( j , k )} = ( \frac{{o}_{( j , k )}}{1 + {o}_{( j , k )}} ) {Q}_{( k )}^{\{ X \}} & ( Equation 21 a ) \\ {T}_{( j , k )} = ( {f}_{( j , k )}^{\{ T \}} ) {X}_{( j , k )} & ( Equation 21 b ) \\ {V}_{( j , k )} = ( {f}_{( j , k )}^{\{ V \}} ) {X}_{( j , k )} & ( Equation 21 c )\end{matrix}$$

The example bounds generator circuitry 214 generates bounds for the multiplier variables (c₍ⱼ₎^{{T}},c₍ⱼ₎^{{V}}). For example, the bounds generator circuitry 214 generates bounds for the multiplier variables for j={1, . . . , N} using the below Equations 22a and 22b.

$$\begin{matrix}0 \leq {c}_{( j )}^{\{ T \}} \leq {min}_{k} ( \frac{{R}_{( j , k )}}{{R}_{( j , k )} - {A}_{( j , k )}} ) & ( Equation 22 a ) \\ - ∞ < {c}_{( j )}^{\{ V \}} \leq {min}_{k} ( \frac{{A}_{( j , k )}}{{D}_{( j , k )}} ) & ( Equation 22 b )\end{matrix}$$

Additionally, the example bounds generator circuitry 214 can determine a finite lower bound for the duration multiplier (c₍ⱼ₎^{{V}}) given that total census impression counts and durations are known. Given two sequences of positive numbers {a₁, . . . , a} and {b₁, . . . , bₙ}, the inequality shown in below example Equation 23 is known to be true.

$${min}_{i} ( \frac{{a}_{i}}{{b}_{i}} ) \leq \frac{{Σ}_{i = 1}^{n} {a}_{i}}{{Σ}_{i = 1}^{n} {b}_{i}} \leq {max}_{i} ( \frac{{a}_{i}}{{b}_{i}} ) \qquad ( Equation 23 )$$

For example, if the total census impression counts and durations are known across all demographics for each dimension ((T_{(j,•)}, V_{(j,•)}) for j={1, . . . , N}), the theorem presented in Equation 23 can be applied, giving Equation 24 below. Summing across both j and k results in Equation 25 below.

$$\begin{matrix}{min}_{k} ( \frac{{T}_{( j , k )}}{{V}_{( j , k )}} ) \leq \frac{{T}_{( j , \cdot )}}{{V}_{( j , \cdot )}} \leq {max}_{k} ( \frac{{T}_{( j , k )}}{{V}_{( j , k )}} ) & ( Equation 24 ) \\ {min}_{j , k} ( \frac{{T}_{( j , k )}}{{V}_{( j , k )}} ) \leq \frac{{T}_{( \cdot , \cdot )}}{{V}_{( \cdot , \cdot )}} \leq {max}_{j , k} ( \frac{{T}_{( j , k )}}{{V}_{( j , k )}} ) & ( Equation 25 )\end{matrix}$$

Applying Equations 21b and 21c to the ratio of the impression count for a given demographic and dimension (j,k) over the duration for a given demographic and dimension (j,k), it can be seen using below example Equations 26a and 26b that the ratio is independent of the unknown value of the audience size for the given demographic and dimension. Using below Equation 26c, it can be seen that the ratio is also linear with respect to the duration multiplier, (c₍ⱼ₎^{{V}}).

$$\begin{matrix}\frac{{T}_{( j , \cdot )}}{{V}_{( j , \cdot )}} = \frac{( {f}_{( j , k )}^{\{ T \}} ) {X}_{( j , k )}}{( {f}_{( j , k )}^{\{ V \}} ) {X}_{( j , k )}} & ( Equation 26 a ) \\ \frac{{T}_{( j , \cdot )}}{{V}_{( j , \cdot )}} = \frac{{f}_{( j , k )}^{\{ T \}}}{{f}_{( j , k )}^{\{ V \}}} & ( Equation 26 b ) \\ \frac{{T}_{( j , \cdot )}}{{V}_{( j , \cdot )}} = {f}_{( j , k )}^{\{ T \}} ( \frac{{A}_{( j , k )}}{D ( j , k )} - {c}_{( j )}^{\{ V \}} ) & ( Equation 26 c )\end{matrix}$$

Let r be the known ratio in the middle of the inequality in either example Equation 23 or example Equation 24. In some examples, the variable r is indexed by j. Additionally, define Q as the summation region (e.g., j={1, . . . , N} and k={1, . . . , K}). By the theorem defined in example Equation 23 above, along with the constraints f^{{T}}≥1 and f^{{v}}≥0, below example Equation 27 can be defined with the definition of s provided in example Equation 28.

$$\begin{matrix}s - r \leq {c}^{\{ V \}} \leq s & ( Equation 27 ) \\ s = {min}_{Ω} ( \frac{{A}_{( j , k )}}{{D}_{( j , k )}} ) & ( Equation 28 )\end{matrix}$$

In the example where the total impression counts across demographics (T_{(j,•)}) and the total durations across demographics (V_{(j,•)}) are known for each dimension, s and r can be defined using example Equations 29a and 29b below. Additionally, the bounds for the duration multiplier (c₍ⱼ₎^{{V}}) depending on index j can be defined using below example Equation 30.

$$\begin{matrix}{s}_{j} = {min}_{j} ( \frac{{A}_{( j , k )}}{{D}_{( j , k )}} ) & ( Equation 29 a ) \\ {r}_{j} = \frac{{T}_{( j , \cdot )}}{{V}_{( j , \cdot )}} & ( Equation 29 b ) \\ {s}_{j} - {r}_{j} \leq {c}_{( j )}^{\{ V \}} \leq {s}_{j} & ( Equation 30 )\end{matrix}$$

In the example where only total impression counts across demographics and dimensions (T_{(•,•)}) and total durations across demographics and dimensions (V_{(•,•)}) are known, Equations 29a, 29b, and 30 can be re-written as below example Equations 31a, 31b, and 32.

$$\begin{matrix}s = {min}_{j , k} ( \frac{{A}_{( j , k )}}{{D}_{( j , k )}} ) & ( Equation 31 a ) \\ r = \frac{{T}_{( \cdot , \cdot )}}{{V}_{( \cdot , \cdot )}} & ( Equation 31 b ) \\ s - r \leq {c}^{\{ V \}} \leq s & ( Equation 32 )\end{matrix}$$

The application of the theorem of Equation 23 allows the example bounds generator circuitry 214 to define a finite search space for the duration multiplier (c^{{V}}) contingent on known total impression counts and total durations. The example bounds generator circuitry 214 defines bounds for the duration multiplier (c^{{V}}) using above Equations 30 and 32 depending on the known total impression counts and total durations. Using the above example Equation 22a along with either Equation 30 or 32, the example bounds generator circuitry 214 defines finite bounds for both the impression multiplier (c^{{V}}) and the duration multiplier (c^{{V}}). Thus, the Lagrange multiplier controller circuitry 218 can solve for a solution for the impression multiplier (c^{{V}}) and the duration multiplier (c^{{V}}) within the bounds that satisfies the constraint equations.

In order for the example Lagrange multiplier controller circuitry 218 to solve for the impression multiplier(s) and the duration multiplier(s), the example metrics calculator circuitry 216 determines the relationship variable (o_{(j,k)}) for each index (j,k), the total audience across all dimensions for each demographic (X_{(•,k)}), and the pseudo-universe estimate for each demographic (Q₍ₖ₎^{{d}}) as a function of the Lagrange impression multiplier (c^{{T}}) and the duration multiplier (c^{{V}}). For example, the metrics calculator circuitry 216 uses example Equations 13a, 13b, and 13c to determine the relationship variable (o_{(j,k)}) for each index as a function of the impression multiplier and the duration multiplier. Next, the example metrics calculator circuitry 216 inserts relationship variable (o_{(j,k)}) for each index into example Equation 20a to determine the total audience sizes across all dimensions for each demographic (X_{(•,k)}) as a function of the impression multiplier and the duration multiplier. Further, the example metrics calculator circuitry 216 inserts the total audience sizes across all dimensions for each demographic (X_{(•,k)}) into example Equation 20b to determine the pseudo-universe estimate for each demographic (Q₍ₖ₎^{{X}}) as a function of the impression multiplier and the duration multiplier.

Once the pseudo-universe estimate for each demographic (Q₍ₖ₎^{{V}}) as a function of the impression and duration multipliers is determined by the example metrics calculator circuitry 216, the example metrics calculator circuitry can solve for the audience size (X_{(j,k)}), impression count (T_{(j,k)}), and durations (V_{(j,k)}), for each demographic and dimension index (j,k) as a function of the impression and duration multipliers (c^{{T}}) and c^{{V}}) For example, the metrics calculator circuitry 216 inserts the relationship value (o_{(j,k)}) and the pseudo-universe estimate for the demographic (Q₍ₖ₎^{{V}}) into Equation 21a to determine the audience size (X_{(j,k)}) for a given index as a function of the impression and duration multipliers. Next, the example metrics calculator circuitry 216 can insert the audience size (X_{(j,k)}) into Equation 21b to determine the impression count (T_{(j,k)}) for the given index as a function of the impression and duration multipliers. Additionally, the example metrics calculator circuitry 216 can insert the audience size (X_{(j,k)}) into Equation 21c to determine the duration (V_{(j,k)}) for the given index as a function of the impression and duration multipliers. The example metrics calculator circuitry 216 can repeat the above steps to determine the audience size (X_{(j,k)}), impression count (T_{(j,k)}), and durations (V_{(j,k)}), for each demographic and dimension index as a function of the impression and duration multipliers.

In order to solve for the impression and duration multipliers, and, thus, the census-level metrics, the example Lagrange multiplier controller circuitry 218 first sets initial values for the impression multiplier (c^{{T}}) and the duration multiplier (c^{{V}}) within the bounds. For example, as explained above, the bounds can be defined by the bounds generator circuitry 214 using example Equation 22a and Equation 30 or Equation 32. The example Lagrange multiplier controller circuitry 218 can set an initial value of the impression multiplier (c^{{T}}) within the bounds defined by Equation 22a. For example, the Lagrange multiplier controller circuitry 218 sets the initial value of the impression multiplier (c^{{T}}) as the lower bound of Equation 22a. In another example, the Lagrange multiplier controller circuitry 218 sets the initial value of the impression multiplier (c^{{T}}) as the upper bound of Equation 22a. In another example, the Lagrange multiplier controller circuitry 218 sets the initial value of the impression multiplier (c^{{T}}) as any value between the lower and upper bound defined in Equation 22a. Additionally, the example Lagrange multiplier controller circuitry 218 can set an initial value of the duration multiplier (c^{{V}}) within the bounds defined by Equation 30 or Equation 32. For example, the Lagrange multiplier controller 218 sets the initial value of the duration multiplier (c^{{V}}) as the lower bound of Equation 30 or Equation 32. In another example, the Lagrange multiplier controller circuitry 218 sets the initial value of the duration multiplier (c^{{V}}) as the upper bound of Equation 30 or Equation 32. In another example, the Lagrange multiplier controller 218 sets the initial value of the duration multiplier (c^{{V}}) as any value between the lower and upper bound defined in Equation 30 or Equation 32.

Once initial values are set for the impression multiplier (c^{{T}}) and the duration multiplier (c^{{V}}), the example metrics calculator circuitry 216 determines values for each of the audience sizes (X_{(j,k)}), impression counts (T_{(j,k)}), and durations (V_{(j,k)}) for each demographic and dimension index (j,k) using the equations determined previously as a function of the impression and duration multipliers. Next, the example constraint equation controller circuitry 212 determines if the constraint equations are met given the values of the impression counts (T_{(j,k)}) and durations (V_{(j,k)}) for each demographic and dimension index (j,k) determined by the metrics calculator circuitry 216. For example, if the total census impression counts and total census duration data are known for each dimension across all demographics, the example constraint equation controller circuitry 212 can insert the impression counts and durations into the 2*n constraint equations selected from Equations 8a and 8b and check if the constraint equations are met (e.g., the equality holds true). In another example, if total census impression counts and total census duration data are only known across all dimensions and across all demographics, the constraint equation controller circuitry 212 can insert the impression counts and durations into the two constraint equations selected from Equations 9a and 9b to check if the constraint equations are met (e.g., the equality holds true).

If the example constraint equation controller circuitry 212 determines that any of the constraint equations are not met (e.g., the equality did not hold true), the Lagrange multiplier controller circuitry 218 varies the value of the impression and/or duration multiplier within the bounds determined by the bounds generator circuitry 214. Using the updated values of the impression and duration multipliers, the example metrics calculator circuitry 216 determines updated values for each of the audience sizes (X_{(j,k)}), impression counts (T_{(j,k)}), and durations (V_{(j,k)}) for each demographic and dimension index (j,k). Further, the example constraint equation controller circuitry 212 again checks if the constraint equations are met. If any of the constraint equations are not met, the audience metrics generator circuitry 126 repeats the above process of updating the impression and/or duration multipliers and checking if the constraint equations are met. If the example constraint equation controller circuitry 212 determines that all constraint equations are met, the example Lagrange multiplier controller circuitry 218 determines that it has found the solutions for the impression and duration multipliers and the iterative process ends.

The example census-level metrics generator circuitry 220 determines census-level metrics (e.g., census audience sizes, census impression counts, and census durations) for each demographic and dimension. For example, the census-level metrics generator circuitry 220 uses the solutions for the impression and duration multipliers found by the Lagrange multiplier controller circuitry along with Equations 21a, 21b, and 21c to determine the census-level metrics. Additionally, the example census-level metrics generator circuitry 220 can compile the census-level audience sizes, census-level impression counts, and census-level durations into an audience metrics table. In some examples, the census-level metrics generator circuitry 220 populates missing fields in a previous audience metrics table to generate the audience metrics table including census-level metrics for each demographic and duration. The audience metrics table including the census-level metrics for each demographic and duration may be stored in the audience metrics data storage 204. The example reporter circuitry 206 can transmit the audience metrics table including the census-level metrics to a customer (e.g., the customer 114 of FIG. 1). For example, the reporter circuitry 206 can transmit the audience metrics table to the customer 114 via the network 108.

FIG. 3 is an example table 300 showing audience metrics for a demographic index, k, with a population U₍ₖ₎, for a plurality of dimensions 302 (j=1 . . . n). The example table 300 includes DP panel-level metrics 304 including DP panel audience sizes (A_{(j,k)}), DP panel impression counts (R_{(j,k)}), and DP panel duration data (D_{(j,k)}). The example table 300 includes total DP panel-level metrics data. For example, the table 300 includes a total deduplicated DP panel audience size (A_{(•,k)}), total DP panel impression counts (R_{(•,k)}, and total DP panel duration data (D_{(•,k)}) for the demographic (k) across all dimensions. As discussed above, while the total audience size is a deduplicated value counting each unique audience member only once, the total impression counts and total duration data are simple summations across all dimensions. The example table 300 also includes census-level metrics 306 including census audience sizes (X_{(j,k)}), census impression counts (T_{(j,k)}), and census duration data (V_{(j,k)}). The example table 300 includes total census-level metrics data. For example, the table 300 includes a total deduplicated census audience size (X_{(•,k)}), total census impression counts (T_{(•,k)}), and total census duration data (V_{(•,k)}) for the demographic (k) across all dimensions.

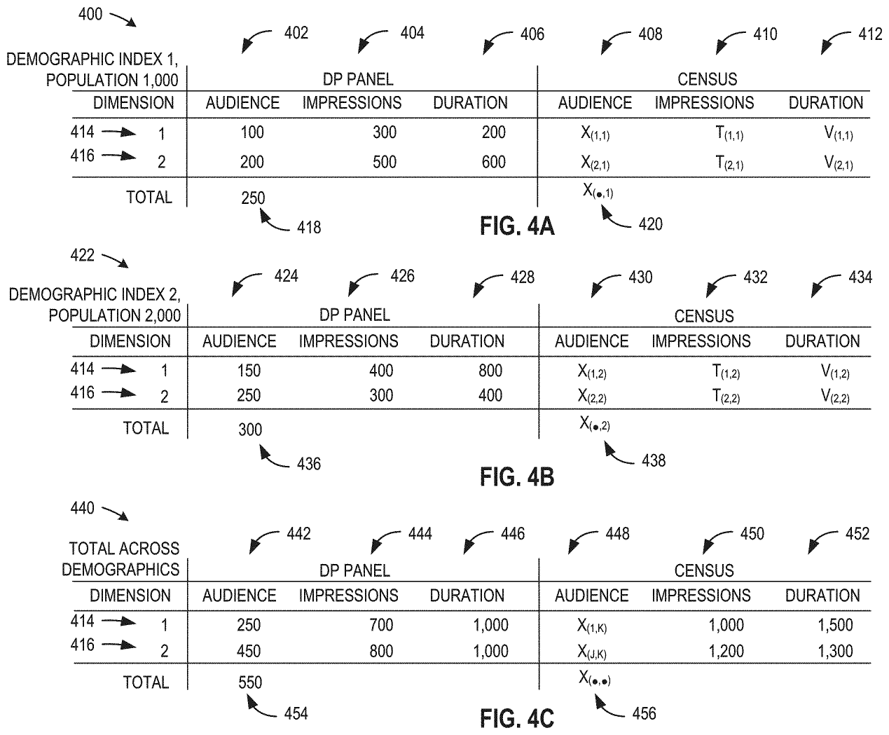

FIG. 4A is an example audience metrics table 400 for a first demographic index (e.g., demographic index 1, population 1,000). The first demographic index has a population (U₁) of 1,000. The example audience metrics table 400 includes known values for DP panel audience sizes 402, DP panel impression counts 404, and DP panel durations 406. Additionally, the example audience metrics table 400 includes unknown values for census audience sizes 408, census impression counts 410, and census durations 412 for the first demographic index. The audience metrics provided in the example table 400 are given for a first dimension 414 (e.g., event, media item, etc.) and a second dimension 416 (e.g., event, media item, etc.). Additionally, the example audience metrics table 400 includes a known total deduplicated DP panel audience size 418 for the first demographic index and an unknown total deduplicated census audience size 420 for the first demographic index.

FIG. 4B is an example audience metrics table 422 for a second demographic index (e.g., demographic index 2, population 2,000). The second demographic index has a population (U₂) of 2,000. The example audience metrics table 422 includes known values for DP panel audience sizes 424, DP panel impression counts 426, and DP panel durations 428. Additionally, the example audience metrics table 422 includes unknown values for census audience sizes 430, census impression counts 432, and census durations 434 for the second demographic index. The audience metrics provided in the example table 422 are given for the first dimension 414 (e.g., event, media item, etc.) and the second dimension 416 (e.g., event, media item, etc.). Additionally, the example audience metrics table 422 includes a known total deduplicated DP panel audience size 436 for the second demographic index and an unknown total deduplicated census audience size 438 for the second demographic index.

FIG. 4C is an example audience metrics table 440 that includes total audience metrics across all demographics (e.g., the first demographic index and the second demographic index). The example audience metrics table 440 includes known values for total DP panel audience sizes 442, total DP panel impression counts 444, total DP panel durations 446, total census impression counts 450 and total census durations 452 across all demographics for the first dimension 414 and the second dimension 416. Additionally, the example audience metrics table 422 includes unknown values for total census audience sizes 448. Additionally, the example audience metrics table 440 includes a known total deduplicated DP panel audience size 454 for the total across demographics and an unknown total deduplicated census audience size 456 for the total across demographics.

Examples disclosed herein can be used to determine the unknown census audience metrics of tables 400, 422, and 440 of FIGS. 4A, 4B, and 4C using the known DP panel audience sizes 402, 424, 442, known DP panel impression counts 404, 426, 444, known DP panel durations 406, 428, 446 and known total census impression counts 450 and total duration data 452 across all demographics for each dimension. The determined census audience metrics are shown in the below FIGS. 5A, 5B, and 5C.

FIG. 5A is an example audience metrics table 500 for the first demographic index (e.g., demographic index 1, population 1,000) including census-level audience metrics determined using examples disclosed herein. For example, the census-level audience sizes 408, the census-level impression counts 410, and the census-level duration data 412 for the first dimension 414 and the second dimension 416 for the first demographic index are populated in the table 500 of FIG. 5A. Additionally, the total deduplicated census-level audience size 420 for the first demographic index across all dimensions is known in the example of FIG. 5A.

FIG. 5B is an example audience metrics table 502 for the second demographic index (e.g., demographic index 2, population 2,000) including census-level audience metrics determined using examples disclosed herein. For example, the census-level audience sizes 430, the census-level impression counts 432, and the census-level duration data 434 for the first dimension 414 and the second dimension 416 for the second demographic index are populated in the table 502 of FIG. 5B. Additionally, the total deduplicated census-level audience size 438 for the second demographic index across all dimensions is known in the example of FIG. 5B.

FIG. 5C is an example audience metrics table 504 including census-level audience metrics determined using examples disclosed herein for the total across all demographics. For example, the total census-level audience sizes 448 for each dimension across all demographics and the total deduplicated census-level audience size 456 across all dimensions and all demographics are populated in the table 504 of FIG. 5C.

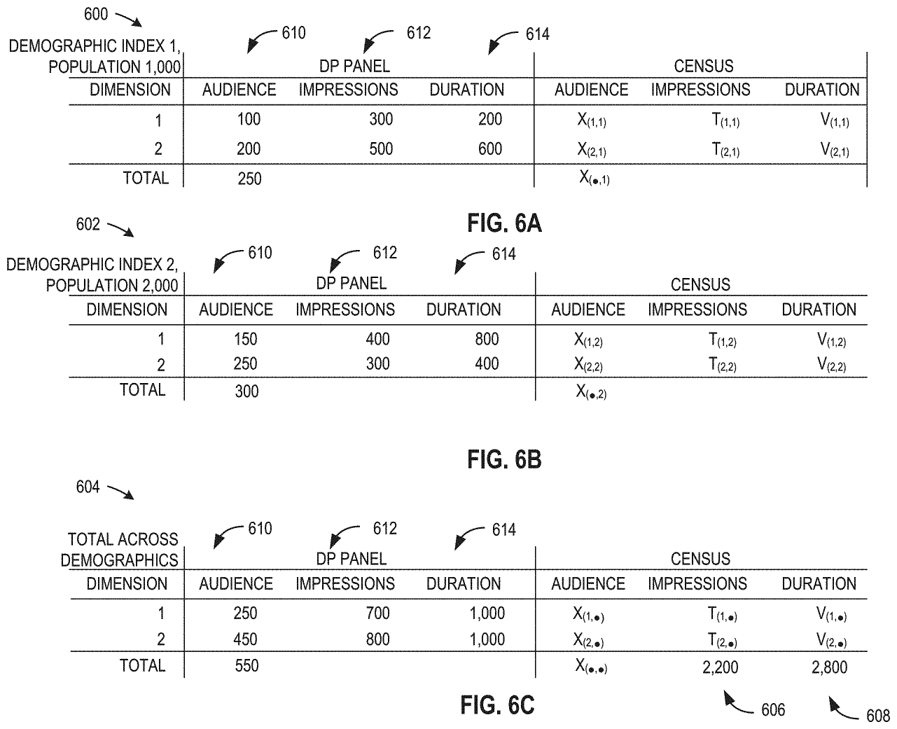

FIG. 6A is an example audience metrics table 600 including the audience metrics for the first demographic index (e.g., demographic index 1, population 1,000) included in the audience metrics table 400 of FIG. 4A. FIG. 6B is an example audience metrics table 602 including the audience metrics for the second demographic index (e.g., demographic index 2, population 2,000) included in the audience metrics table 422 of FIG. 4B. FIG. 6C is an example audience metrics table 604 including audience metrics across all demographics (e.g., the first demographic index and the second demographic index). In contrast to FIG. 4C, the table 604 of FIG. 6C includes only total census impression counts 606 and total census duration data 608 across all demographics and all dimensions.

Examples disclosed herein can be used to determine the unknown census audience metrics of tables 600, 602, and 604 of FIGS. 6A, 6B, and 6C using the known DP panel audience sizes 610, known DP panel impression counts 612, known DP panel duration data 614 and known total census impression counts 606 and total duration data 608 across all demographics and all dimensions. The determined census audience metrics are shown in the below FIGS. 7A, 7B, and 7C.

FIG. 7A is an example audience metrics table 700 for the first demographic index (e.g., demographic index 1, population 1,000) including census-level audience metrics determined using examples disclosed herein. For example, the census-level audience sizes 702, the census-level impression counts 704, and the census-level duration data 706 for the first dimension 414 and the second dimension 416 for the first demographic index are populated in the table 700 of FIG. 7A. Additionally, the total deduplicated census-level audience size 708 for the first demographic index across all dimensions is known in the example of FIG. 7A. Because different constraints were used to determine the census-level metrics of the table 700 of FIG. 7A than were used to determine the census-level metrics of the table 500 of FIG. 5A, the census-level metrics have different values in FIG. 7A than in FIG. 5A. For example, the audience size for the first dimension 414 for the first demographic is 136 in the example of FIG. 7A. In the example of FIG. 5A, the audience size for the first dimension 414 for the first demographic is 129.

FIG. 7B is an example audience metrics table 710 for the second demographic index (e.g., demographic index 2, population 2000) including census-level audience metrics determined using examples disclosed herein. For example, the census-level audience sizes 712, the census-level impression counts 714, and the census-level duration data 716 for the first dimension 414 and the second dimension 416 for the second demographic index are populated in the table 502 of FIG. 5B. Additionally, the total deduplicated census-level audience size 718 for the second demographic index across all dimensions is known in the example of FIG. 7B. Similar to FIG. 7A, because different constraints were used to determine the census-level metrics of the table 710 of FIG. 7B than were used to determine the census-level metrics of the table 502 of FIG. 5B, the census-level metrics have different values in FIG. 7B than in FIG. 5B. For example, the impression count for the second dimension 416 for the second demographic is 372 in the example of FIG. 7B. In the example of FIG. 5B, the impression count for the second dimension 416 for the second demographic is 380.

FIG. 7C is an example audience metrics table 720 including census-level audience metrics determined using examples disclosed herein for the total across all demographics. For example, the total census-level audience sizes 722, the total census-level impression counts 724, and the total duration data 726 for each dimension across all demographics and the total deduplicated census-level audience size 728 across all dimensions and all demographics are populated in the table 720 of FIG. 7C.

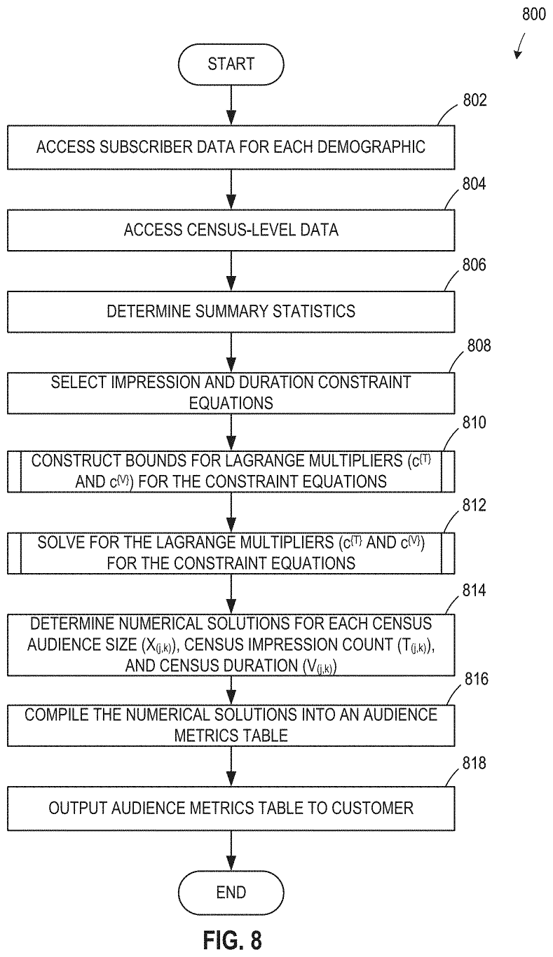

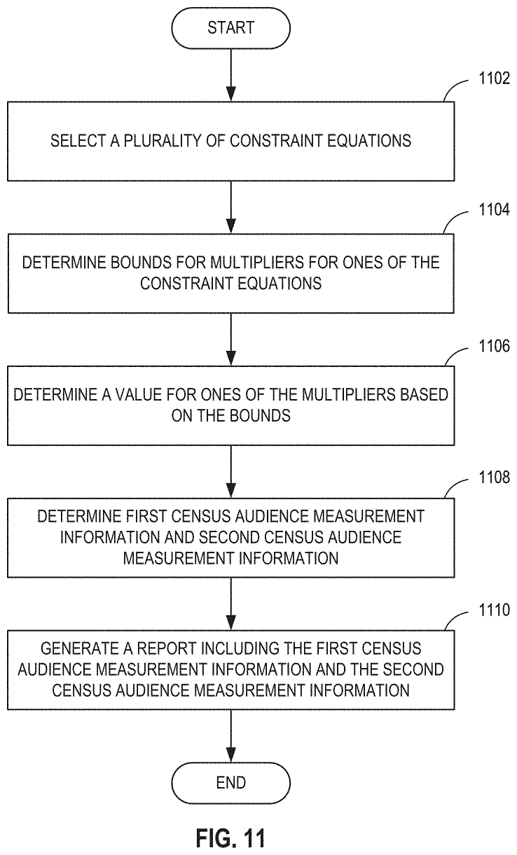

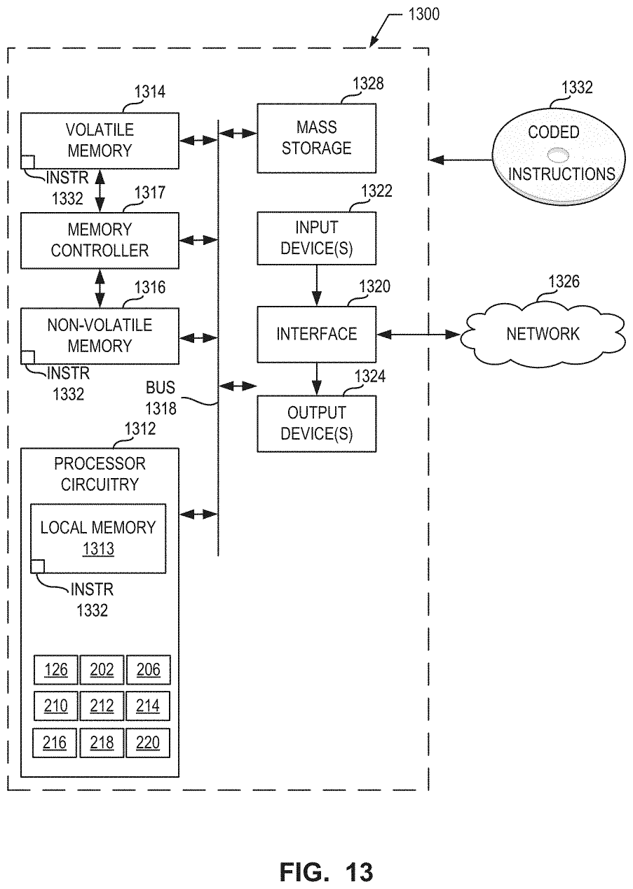

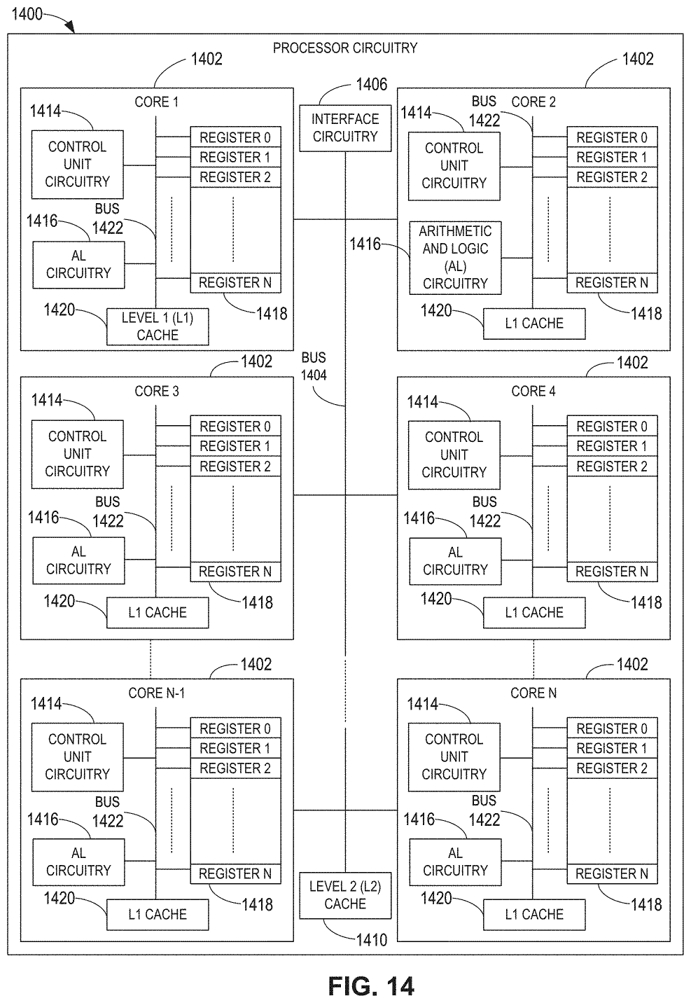

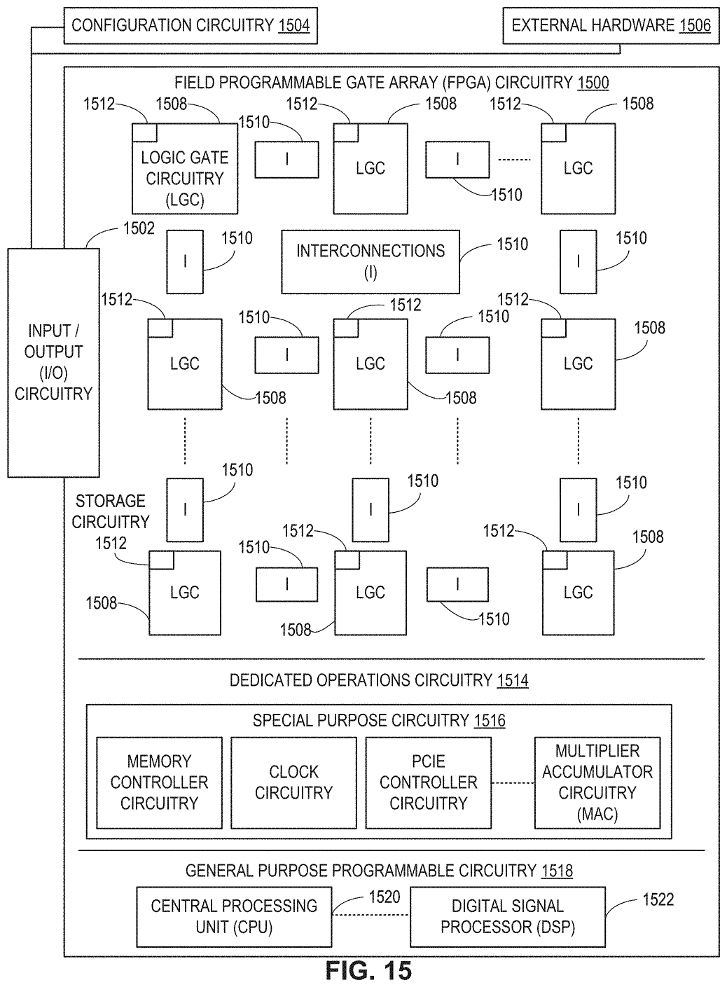

In some examples, the apparatus includes means for selecting a plurality of constraint equations. For example, the means for selecting constraint equations may be implemented by constraint equation controller circuitry 212. In some examples, the constraint equation controller circuitry 212 may be implemented by machine executable instructions such as that implemented by at least blocks 808 of FIG. 8 and 1102 of FIG. 11 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the constraint equation controller circuitry 212 is implemented by other hardware logic circuitry, hardware implemented state machines, and/or any other combination of hardware, software, and/or firmware. For example, the constraint equation controller circuitry 212 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

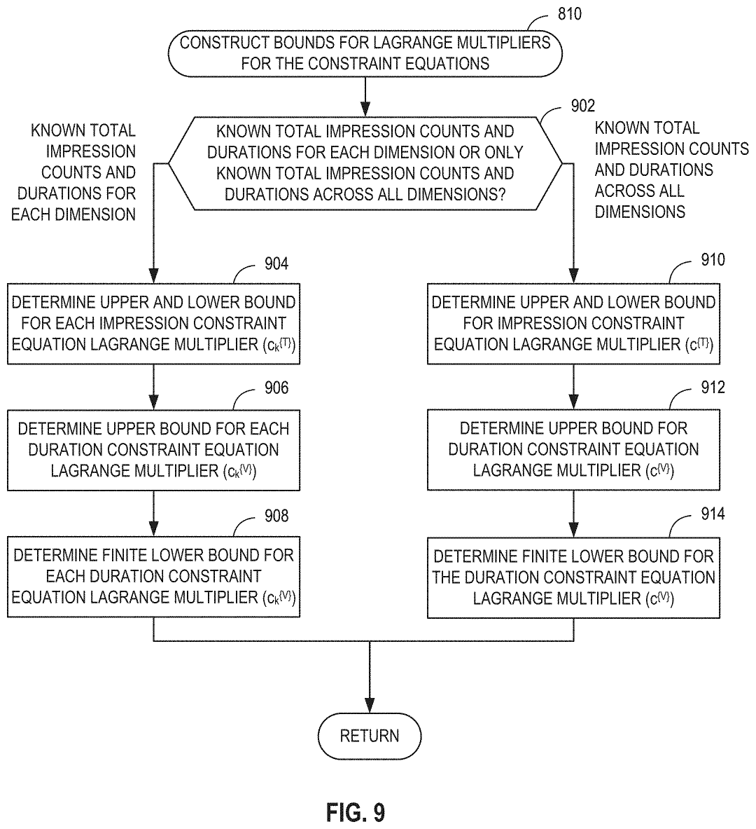

In some examples, the apparatus includes means for determining bounds for a multiplier for ones of the constraint equations. For example, the means for determining bounds may be implemented by bounds generator circuitry 214. In some examples, the bounds generator circuitry 214 may be implemented by machine executable instructions such as that implemented by at least blocks 810 of FIG. 8, 902, 904, 906, 908, 910, 912, 914 of FIG. 9, and 1104 of FIG. 11 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the bounds generator circuitry 214 is implemented by other hardware logic circuitry, hardware implemented state machines, and/or any other combination of hardware, software, and/or firmware. For example, the bounds generator circuitry 214 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for determining a value for ones of the multipliers. For example, the means for determining a value for ones of the multipliers may be implemented by Lagrange multiplier controller circuitry 218. In some examples, the Lagrange multiplier controller circuitry 218 may be implemented by machine executable instructions such as that implemented by at least blocks 812 of FIG. 8, 1002, 1004, 1006, 1008, 1010, 1012, 1014, 1016 of FIG. 10 and 1106 of FIG. 11 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the Lagrange multiplier controller circuitry 218 is implemented by other hardware logic circuitry, hardware implemented state machines, and/or any other combination of hardware, software, and/or firmware. For example, the Lagrange multiplier controller circuitry 218 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for determining census information. For example, the means for determining census information may be implemented by census-level metrics generator circuitry 220. In some examples, the census-level metrics generator circuitry 220 may be implemented by machine executable instructions such as that implemented by at least blocks 814 of FIG. 8 and 1108 of FIG. 11 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the census-level metrics generator circuitry 220 is implemented by other hardware logic circuitry, hardware implemented state machines, and/or any other combination of hardware, software, and/or firmware. For example, the census-level metrics generator circuitry 220 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

In some examples, the apparatus includes means for generating a report. For example, the means for generating a report may be implemented by reporter circuitry 206. In some examples, the reporter circuitry 206 may be implemented by machine executable instructions such as that implemented by at least blocks 818 of FIG. 8 and 1110 of FIG. 11 executed by processor circuitry, which may be implemented by the example processor circuitry 1312 of FIG. 13, the example processor circuitry 1400 of FIG. 14, and/or the example Field Programmable Gate Array (FPGA) circuitry 1500 of FIG. 15. In other examples, the reporter circuitry 206 is implemented by other hardware logic circuitry, hardware implemented state machines, and/or any other combination of hardware, software, and/or firmware. For example, the reporter circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to perform the corresponding operation without executing software or firmware, but other structures are likewise appropriate.

While an example manner of implementing the audience metrics generator circuitry 126 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 202, the example reporter circuitry 206, the example statistics generator circuitry 210, the example constraint equation controller circuitry 212, the example bounds generator circuitry 214, the example metrics calculator circuitry 216, the example Lagrange multiplier controller circuitry 218, the example census-level metrics generator circuitry 220, and/or, more generally, the example audience metrics generator circuitry 126 of FIG. 2, may be implemented by hardware alone or by hardware in combination with software and/or firmware. Thus, for example, any of the example network interface 202, the example reporter circuitry 206, the example statistics generator circuitry 210, the example constraint equation controller circuitry 212, the example bounds generator circuitry 214, the example metrics calculator circuitry 216, the example Lagrange multiplier controller circuitry 218, the example census-level metrics generator circuitry 220, and/or, more generally, the example audience metrics generator circuitry 126, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example audience metrics generator circuitry 126 of FIG. 1 may include one or more elements, processes, and/or devices in addition to, or instead of, those illustrated in FIG. 2, and/or may include more than one of any or all of the illustrated elements, processes and devices.

Flowcharts representative of example hardware logic circuitry, machine readable instructions, hardware implemented state machines, and/or any combination thereof for implementing the audience metrics generator circuitry 126 of FIG. 2 are shown in FIGS. 8-12. The machine readable instructions may be one or more executable programs or portion(s) of an executable program for execution by processor circuitry, such as the processor circuitry 1312 shown in the example processor platform 1300 discussed below in connection with FIG. 13 and/or the example processor circuitry discussed below in connection with FIGS. 14 and/or 15. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program(s) is/are described with reference to the flowcharts illustrated in FIGS. 8-12, many other methods of implementing the example audience metrics generator circuitry 126 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-12 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to determine census-level audience metrics. The machine readable instructions and/or operations 800 of FIG. 8 begin at block 802, at which the network interface 202 (FIG. 2) accesses subscriber data for each demographic. For example, the network interface 202 accesses the subscriber audience size values 118, the subscriber impression count values 120, and the subscriber duration values 122 from the database proprietor via the network 108 of FIG. 1. At block 804, the audience metrics generator circuitry 126 (FIGS. 1 and 2) accesses census-level metrics. For example, the audience metrics generator circuitry 126 accesses the census level database 124 including census total audience size values 128, census total impression count values 130, and census total duration values 132 of FIG. 1 via a direct connection. In other examples, the network interface 202 (FIG. 2) accesses the census level database 124 via the network 108. At block 806, the statistics generator circuitry 210 (FIG. 2) determines summary statistics of the subscriber data. For example, the statistics generator circuitry 210 uses example Equation 7 above to determine the solution for the pseudo-universe estimate for each demographic index (Q₍ₖ₎^{{A}}). Additionally, the example statistics generator circuitry 210 can use the solution for the pseudo-universe estimate for each demographic index (Q₍ₖ₎^{{A}}) to solve for the panel-level statistics of example Equations 6a, 6b, 6b, 6d, and 6e above.

At block 808, the example constraint equation controller circuitry 212 (FIG. 2) selects impression and duration constraint equations. For example, if census-level total impressions (T_{(j,•)}) and total durations (V_{(j,•)}) are known for each dimension across all demographics, the example constraint equation controller circuitry 212 uses example Equations 8a and 8b above to select 2*n constraint equations where n is the number of dimensions. In other examples, if census-level total impressions (T_{(•,•)}) and total durations (V_{(•,•)}) are only known across all dimensions and demographics, the example constraint equation controller circuitry 212 uses example Equations 9a and 9b above to select the two constraint equations. At block 810, the example bounds generator circuitry 214 (FIG. 2) constructs bounds for the Lagrange multipliers for the constraint equations (e.g., the constraint equations selected at block 808). Example instructions that may be used to implement block 810 are discussed below in detail in connection with FIG. 9. At block 812, the example audience metrics generator circuitry 126 solves for the Lagrange multipliers for the constraint equations (e.g., the constraint equations selected at block 808). example instructions that may be used to implement block 810 are discussed below in detail in connection with FIG. 10.

At block 814, the example census-level metrics generator circuitry 220 (FIG. 2) determines numerical solutions for census-level audience metrics. For example, the census-level metrics generator circuitry 220 uses example Equation 21a above to solve for the census-level audience size (X_{(j,k)}) for each demographic and dimensional index. Additionally, the example census-level metrics generator circuitry 220 uses example Equation 21b above to solve for the census-level impression counts (T_{(j,k)}) for each demographic and dimensional index. Additionally, the example census-level metrics generator circuitry 220 uses example Equation 21c above to solve for the census-level duration data (V_{(j,k)}) for each demographic and dimensional index. At block 816, the example census-level metrics generator circuitry 220 compiles the numerical solutions for the census-level metrics into an audience metrics table. At block 818, the example reporter circuitry 206 (FIG. 2) generates a report based on the audience metrics table including the census-level metrics. For example, the example reporter circuitry 206 can generate the report to provide it to a customer (e.g., the customer 114 of FIG. 1). The process of FIG. 8 then ends.

FIG. 9 is a flowchart representative of example machine readable instructions and/or example operations 810 that may be executed and/or instantiated by processor circuitry to determine bounds for the Lagrange multipliers for the constraint equations. The machine readable instructions and/or operations 810 may be used to implement block 810 of FIG. 8. The machine readable instructions and/or operations 810 of FIG. 9 begin at block 902, at which the example bounds generator circuitry 214 (FIG. 2) determines if census-level total impression counts (T_{(j,•)}) and durations (V_{(j,•)}) are known for individual dimensions across all demographics or only census-level total impression count (T_{(•,•)}) and duration (V_{(•,•)}) aggregated across all dimensions and demographics are known. If census-level total impression counts (T_{(j,•)}) and durations (V_{(j,•)}) are known for individual dimensions across all demographics, control continues to block 904 where the example bounds generator circuitry 214 determines upper and lower bounds for each impression constraint equation Lagrange multiplier (cₖ^{{t}}). For example, the bounds generator circuitry 214 uses example Equation 22a above to calculate the upper bound for each Lagrange multiplier (cₖ^{{V}}) corresponding to an impression constraint equation selected at block 808 of FIG. 8. Additionally, based on example Equation 22a, the example bounds generator circuitry 214 determines that the lower bound for each of the impression constraint equation Lagrange multipliers (cₖ^{{T}}) is zero. At block 906, the example bounds generator circuitry 214 determines an upper bound for each duration constraint equation Lagrange multiplier (cₖ^{{V}}). For example, the bounds generator circuitry 214 uses example Equation 22b above to determine the upper bound for each Lagrange multiplier (cₖ^{{V}}) corresponding to a duration constraint equation selected at block 808. At block 908, the example bounds generator circuitry 214 determines a finite lower bound for each duration constraint equation Lagrange multiplier (cₖ^{{V}}). For example, the bounds generator circuitry 214 uses example Equations 29a, 29b, and 30 above to determine the finite lower bound for each Lagrange multiplier (cₖ^{{V}}) corresponding to a duration constraint equation selected at block 808. In this example, the process of FIG. 9 ends and control returns to FIG. 8.

In the example where, at block 902, the example bounds generator circuitry 214 determines that only census-level total impression count (T_{(•,•)}) and duration (V_{(•,•)}) aggregated across all dimensions and demographics are known, control continues to block 910. At block 910, the example bounds generator circuitry 214 determines an upper and a lower bound for the Lagrange multiplier (c^{{T}}) corresponding to the impression constraint equation selected at block 808. For example, the bounds generator circuitry 214 uses example Equation 22a above to calculate the upper bound the impression constraint equation Lagrange multiplier (c^{{T}}). Additionally, based on example Equation 22a above, the example bounds generator circuitry 214 determines that the lower bound for the impression constraint equation Lagrange multiplier (c^{{T}}) is zero. At block 912, the example bounds generator circuitry 214 determines an upper bound for the duration constraint equation Lagrange multiplier (c^{{V}}). For example, the bounds generator circuitry 214 uses example Equation 22b above to determine the upper bound for the Lagrange multiplier (c^{{V}}) corresponding to the duration constraint equation selected at block 808. At block 914, the example bounds generator circuitry 214 determines a finite lower bound for the duration constraint equation Lagrange multiplier (c^{{V}}). For example, the bounds generator circuitry 214 uses example Equations 29a, 29b, and 30 above to determine the finite lower bound for the Lagrange multiplier (c^{{V}}) corresponding to the duration constraint equation selected at block 808. The process of FIG. 9 ends and control returns to FIG. 8.

FIG. 10 is a flowchart representative of example machine readable instructions and/or example operations 812 that may be executed and/or instantiated by processor circuitry to solve for the Lagrange multipliers for the constraint equations. The machine readable instructions and/or operations 812 may be used to implement block 812 of FIG. 8. The machine readable instructions and/or operations 812 of FIG. 10 begin at block 1002, at which the example metrics calculator circuitry 216 determines the relationship variable (o_{(j,k)}) for each demographic and dimensional index as a function of the Lagrange multipliers (c^{{T}}) and c^{{V}}). For example, the metrics calculator circuitry 216 (FIG. 2) determines the relationship variables (o_{(j,k)}) using example Equations 13a, 13b, and 13c above. At block 1004, the example metrics calculator circuitry 216 determines the total census-level audience (X_{(•,k)}) aggregated across all dimensions for each demographic as a function of the Lagrange multipliers (c^{{T}}) and c^{{V}}). For example, the metrics calculator circuitry 216 uses the relationship variables (o_{(j,k)}) and example Equations 16, 19, and 20a above to determine the total census-level audience (X_{(•,k)}) aggregated across all dimensions for each demographic. At block 1006, the example metrics calculator circuitry 216 determines the pseudo-universe estimate for each demographic (Q₍ₖ₎^{{X}}) as a function of the Lagrange multipliers (c^{{T}}) and c^{{V}}). For example, the metrics calculator circuitry 216 uses the results of Equation 16, the total census-level audience (X_{(•,k)}) aggregated across all dimensions for each demographic, and example Equation 20b above to determine the pseudo-universe estimate for each demographic (Q₍ₖ₎^{{X}}).

At block 1008, the example metrics calculator circuitry 216 determines census-level audience sizes (X_{(j,k)}), census-level impression counts (T_{(j,k)}), and census-level durations (V_{(j,k)}) for each demographic and dimension indices as a function of the Lagrange multipliers (c^{{T}} and c^{{V}}). For example, the metrics calculator circuitry 216 uses the relationship variables (o_{(j,k)}), the pseudo-universe estimate for each demographic (Q₍ₖ₎^{{X}}), and example Equation 21a above to determine the census-level audience sizes (X_{(j,k)}). Additionally, the example metrics calculator circuitry 216 uses the results of Equation 13a above, the census-level audience sizes (X_{(j,k)}), and example Equation 21b above to determine the census-level impression counts (T_{(j,k)}). Additionally, the example metrics calculator circuitry 216 uses the results of example 13b above, the census-level audience sizes (X_{(j,k)}), and example Equation 21c above to determine the census-level durations (V_{(j,k)}).

At block 1010, the Lagrange multiplier controller circuitry 218 (FIG. 2) sets an initial value for the impression multiplier(s) (c₍ₖ₎^{{T}}) and the duration multiplier(s) (c₍ₖ₎^{{V}}). For example, the Lagrange multiplier controller circuitry 218 can set the initial value of each of the impression multiplier(s) (c₍ₖ₎^{{t}}) and the duration multiplier(s) (c₍ₖ₎^{{V}}) to be the lower bound of the respective bounds for the multipliers. At block 1012, the example metrics calculator circuitry 216 calculates values for the census-level audience sizes (X_{(j,k)}), the census-level impression counts (T_{(j,k)}), and the census-level durations (V_{(j,k)}) for each demographic and dimension index. For example, the metrics calculator circuitry 216 uses the initial values of the Lagrange multipliers (c₍ₖ₎^{{T}} and c₍ₖ₎^{{V}}) set at block 1010 with the census-level audience sizes (X_{(j,k)}), the census-level impression counts (T_{(j,k)}), and the census-level durations (V_{(j,k)}) determined as a function of the Lagrange multipliers at block 1008 to calculate values for the census-level metrics.

At block 1014, the example constraint equation controller circuitry 212 checks if the constraint equations are satisfied. For example, the constraint equation controller circuitry 212 uses the values of the census-level metrics calculated at block 1012 to check if the constraint equations selected at block 808 (FIG. 8) are satisfied (e.g., the equality holds true). In some examples, the constraint equations selected at block 808 (FIG. 8) are the 2*n constraint equations defined by example Equations 8a and 8b above. In these examples, the constraint equations are satisfied if the known value for the census impression counts for a given dimension (T_{(j,•)}) is equal to the summation of the impression counts across all demographics for the given dimension as defined in the right hand side of Equation 8a above or if the known value for the census durations for a given dimension (V_{(j,•)}) is equal to the summation of the durations across all demographics for the given dimension as defined in the right hand side of Equation 8b above. In other examples, the constraint equations selected at block 808 (FIG. 8) are the two constraint equations defined by example Equations 9a and 9b above. In these examples, the constraint equations are satisfied if the known value for the census impression count aggregated across all demographics and dimensions (T_{(•,•)}) is equal to the summation of the impression counts across all demographics and all dimensions as defined in the right hand side of Equation 9a above or if the known value for the census duration aggregated across all demographics and dimensions (V_{(•,•)}) is equal to the summation of the durations across all demographics and all dimensions as defined in the right hand side of Equation 9b above. If any of the constraint equations are not satisfied (block 1014: NO), the process of FIG. 10 continues at block 1016. At block 1016, the Lagrange multiplier controller circuitry 218 modifies one or more of the impression multiplier(s) (c₍ₖ₎^{{T}}) and the duration multiplier(s) (c₍ₖ₎^{{V}}) within their respective bounds. Then, at block 1012, the example metrics calculator circuitry 216 calculates the census-level metrics based on the modified Lagrange multipliers. At block 1014, the example constraint equation controller circuitry 212 once again checks if the constraint equations are satisfied based on the census-level metrics calculated using the modified Lagrange multipliers. If any of the constraint equations are still not satisfied (block 1014: NO), the process of FIG. 10 returns to block 1016 to modify the Lagrange multiplier(s). If all of the constraint equations are satisfied (block 1014: YES), the process of FIG. 10 ends and control returns to FIG. 8.

FIG. 11 is a flowchart representative of example machine readable instructions and/or example operations 1100 that may be executed and/or instantiated by processor circuitry to determine census-level audience metrics. The machine readable instructions and/or operations 1100 of FIG. 11 begin at block 1102, at which the example constraint equation controller circuitry 212 (FIG. 2) selects a plurality of constraint equations based on census audience measurement data corresponding to a first demographic group and a second demographic group. For example, if only a total impression count and a total duration aggregated across all dimensions and demographics are known, the example constraint equation controller circuitry 212 selects example Equations 9a and 9b above where the total number of demographic groups (K) is at least two with k=1 corresponding to the first demographic group and k=2 corresponding to the second demographic group. At block 1104, the example bounds generator circuitry 214 (FIG. 2) determines bounds for multipliers for ones of the constraint equations based on the census audience measurement data. For example, the example bounds generator circuitry 214 determines an upper bound and a lower bound for each of the Lagrange multipliers corresponding to the one or more impression constraint equations and the one or more duration constraint equations using the process of FIG. 9. At block 1106, the example Lagrange multiplier controller circuitry 218 (FIG. 2) determines a value for ones of the multipliers based on the bounds, the value to satisfy the constraint equations. For example, using the iterative process of FIG. 10, the example Lagrange multiplier controller circuitry 218 sets an initial value within the determined bounds for each of the Lagrange multipliers (c₍ₖ₎^{{T}}) corresponding to the impression constraint equation(s) and each of the Lagrange multipliers (c₍ₖ₎^{{V}}) corresponding to the duration constraint equation(s). In some examples, the Lagrange multiplier controller circuitry 518 modifies the value of each of the Lagrange multipliers within their respective bounds if the constraint equations are not satisfied. At block 1108, the example census-level metrics generator circuitry 220 (FIG. 2) determines first census audience measurement information and second census audience measurement information based on the multipliers, panel audience measurement data, and the census audience measurement data, the first census audience measurement information corresponding to the first demographic group, the second census audience measurement information corresponding to the second demographic group. For example, the example census-level metrics generator circuitry 220 can use example Equations 21a, 21b, and 21c above to solve for the census-level audience size (X_{(j,k)}), the census-level impression counts (T_{(j,k)}), the census-level duration data (V_{(j,k)}) for each demographic and dimension index. At block 1110, the example reporter circuitry 206 (FIG. 2) generates a report including the first census audience measurement information and the second census audience measurement information. For example, the example reporter circuitry 206 can generate a report including the census-level audience size (X_{(j,k)}), the census-level impression counts (T_{(j,k)}), the census-level duration data (V_{(j,k)}) determined at block 1108 for each demographic and dimension index. The process of FIG. 11 then ends.

FIG. 12 is a flowchart representative of example machine readable instructions and/or example operations 1200 that may be executed and/or instantiated by processor circuitry to determine census-level audience metrics. The machine readable instructions and/or operations 1200 of FIG. 12 begin at block 1202, at which an example processor 1312 (FIG. 13) determines a census-level impression count that includes impressions corresponding to durations measured in different units of time. For example, a first impression can have a first duration measured in hours, and a second impression can have a second duration measured in minutes.

At block 1204, the processor 1312 selects a unit of time (e.g., hours, minutes, seconds) and scales (e.g., converts) the durations of the impressions by the selected unit of time. For example, if the selected unit of time is hours, the example second duration which was measured in minutes is scaled (e.g., converted) to be represented in hours. Although the unit of time to represent the second impression changed, the length of the time elapsed of the second impression did not change during the example scaling process. For example, if the duration of the second impression is 66 minutes, the operation of block 1204 scales (e.g., converts) the duration of the second impression to be represented as 1.10 hours.

At block 1206, the example processor 1312 selects a demographic {k} to process. For example, a first demographic could be 13-17 year-old male, female audience members. At block 1208, the example processor 1312 selects a dimension {j} inside selected demographic {k} to process. For example, a first dimension could be audience members that accessed a first video. The intersection of a selected demographic {k} and a selected dimension {j} is referred to as a dimension-demographic domain. As used herein, a dimension-demographic domain refers to a grouping or pairing of one dimension and one demographic such as 13-17 year-old audience members (e.g., demographic) that accessed a particular video (e.g., dimension). For example, 13-17 year-olds that accessed a first video correspond to a first dimension-demographic domain, and 18-25 year-olds that accessed a second video correspond to a second dimension-demographic domain.

At block 1210, the example processor 1312 calculates a frequency space for the selected dimension {j} of selected demographic {k} based on a census-level impression count (T) for each dimension summed across the demographics and a census-level duration (V) for each dimension summed across the demographics.

At block 1212, the example processor 1312 calculates a demographic estimate of total unique audience sizes deduplicated across multiple dimensions (X_{(•,k)}) based on the calculated frequency space o and a demographic total universal audience size U₍ₖ₎. As used herein, (X_{(•,k)}) refers to the audience sizes deduplicated across multiple dimensions (e.g., the unique audience size that accessed any one or more of a first video, a second video, a third video, etc.) for an individual demographic (e.g., 13-17 year-olds). As used herein, the dot (e.g., typographical bullet point symbol) of (X_{(•,k)}) refers to the universe of dimensions the database proprietor is analyzing.

At block 1214, the example processor 1312 calculates a pseudo-universe estimate for each demographic (Q) based on the calculated demographic estimate of total unique audience sizes deduplicated across multiple dimensions (X_{(•,k)}). At block 1216, the example processor 1312 determines whether there is another dimension to process. For example, if the example processor 1312 determines there is an additional dimension to process, control returns to block 1208 to select another dimension {j} inside selected demographic {k} to process. If the example processor 1312 determines there is not an additional dimension to process, control advances to block 1218.

At block 1218, the example processor 1312 determines whether there is another demographic to process. For example, if the example processor 1312 determines there is an additional demographic to process, control returns to block 1206 to select a demographic. If the example processor 1312 determines there is not an additional demographic to process, control advances to block 1220. At block 1220, the example processor 1312 calculates an audience size (X), an impression count (T), and continuous durations (V) for each dimension across the demographics based on the calculated pseudo-universe estimate (Q) for each demographic. The example program 1200 ends.

FIG. 13 is a block diagram of an example processor platform 1300 structured to execute and/or instantiate the machine readable instructions and/or operations of FIGS. 8-12 to implement the audience metrics generator circuitry 126 of FIG. 2. The processor platform 1300 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1300 of the illustrated example includes processor circuitry 1312. The processor circuitry 1312 of the illustrated example is hardware. For example, the processor circuitry 1312 can be implemented by one or more integrated circuits, logic circuits, FPGAs microprocessors, CPUs, GPUs, DSPs, and/or microcontrollers from any desired family or manufacturer. The processor circuitry 1312 may be implemented by one or more semiconductor based (e.g., silicon based) devices. In this example, the processor circuitry 1312 implements the audience metrics generator circuitry 126, the network interface 202, the reporter circuitry 206, the statistics generator circuitry 210, the constraint equation controller circuitry 212, the bounds generator circuitry 214, the metrics calculator circuitry 216, the Lagrange multiplier controller circuitry 218, and the census-level metrics generator circuitry 220.

The processor circuitry 1312 of the illustrated example includes a local memory 1313 (e.g., a cache, registers, etc.). The processor circuitry 1312 of the illustrated example is in communication with a main memory including a volatile memory 1314 and a non-volatile memory 1316 by a bus 1318. The volatile memory 1314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1316 may be implemented by flash memory and/or any other desired type of memory device. Access to the main memory 1314, 1316 of the illustrated example is controlled by a memory controller 1317.

The processor platform 1300 of the illustrated example also includes interface circuitry 1320. The interface circuitry 1320 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1322 are connected to the interface circuitry 1320. The input device(s) 1322 permit(s) a user to enter data and/or commands into the processor circuitry 1312. The input device(s) 1322 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuitry 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1320 of the illustrated example, thus, typically includes a graphics driver card, a graphics driver chip, and/or graphics processor circuitry such as a GPU.

The interface circuitry 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1326. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1300 of the illustrated example also includes one or more mass storage devices 1328 to store software and/or data. Examples of such mass storage devices 1328 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1332, which may be implemented by the machine readable instructions of FIGS. 8-12, may be stored in the mass storage device 1328, in the volatile memory 1314, in the non-volatile memory 1316, and/or on a removable non-transitory computer readable storage medium such as a CD or DVD.

FIG. 14 is a block diagram of an example implementation of the processor circuitry 1312 of FIG. 13. In this example, the processor circuitry 1312 of FIG. 13 is implemented by a microprocessor 1400. For example, the microprocessor 1400 may implement multi-core hardware circuitry such as a CPU, a DSP, a GPU, an XPU, etc. Although it may include any number of example cores 1402 (e.g., 1 core), the microprocessor 1400 of this example is a multi-core semiconductor device including N cores. The cores 1402 of the microprocessor 1400 may operate independently or may cooperate to execute machine readable instructions. For example, machine code corresponding to a firmware program, an embedded software program, or a software program may be executed by one of the cores 1402 or may be executed by multiple ones of the cores 1402 at the same or different times. In some examples, the machine code corresponding to the firmware program, the embedded software program, or the software program is split into threads and executed in parallel by two or more of the cores 1402. The software program may correspond to a portion or all of the machine readable instructions and/or operations represented by the flowchart of FIGS. 8-12.

The cores 1402 may communicate by an example bus 1404. In some examples, the bus 1404 may implement a communication bus to effectuate communication associated with one(s) of the cores 1402. For example, the bus 1404 may implement at least one of an Inter-Integrated Circuit (I2C) bus, a Serial Peripheral Interface (SPI) bus, a PCI bus, or a PCIe bus. Additionally or alternatively, the bus 1404 may implement any other type of computing or electrical bus. The cores 1402 may obtain data, instructions, and/or signals from one or more external devices by example interface circuitry 1406. The cores 1402 may output data, instructions, and/or signals to the one or more external devices by the interface circuitry 1406. Although the cores 1402 of this example include example local memory 1420 (e.g., Level 1 (L1) cache that may be split into an L1 data cache and an L1 instruction cache), the microprocessor 1400 also includes example shared memory 1410 that may be shared by the cores (e.g., Level 2 (L2_cache)) for high-speed access to data and/or instructions. Data and/or instructions may be transferred (e.g., shared) by writing to and/or reading from the shared memory 1410. The local memory 1420 of each of the cores 1402 and the shared memory 1410 may be part of a hierarchy of storage devices including multiple levels of cache memory and the main memory (e.g., the main memory 1314, 1316 of FIG. 13). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1402 may be referred to as a CPU, DSP, GPU, etc., or any other type of hardware circuitry. Each core 1402 includes control unit circuitry 1414, arithmetic and logic (AL) circuitry (sometimes referred to as an ALU) 1416, a plurality of registers 1418, the L1 cache 1420, and an example bus 1422. Other structures may be present. For example, each core 1402 may include vector unit circuitry, single instruction multiple data (SIMD) unit circuitry, load/store unit (LSU) circuitry, branch/jump unit circuitry, floating-point unit (FPU) circuitry, etc. The control unit circuitry 1414 includes semiconductor-based circuits structured to control (e.g., coordinate) data movement within the corresponding core 1402. The AL circuitry 1416 includes semiconductor-based circuits structured to perform one or more mathematic and/or logic operations on the data within the corresponding core 1402. The AL circuitry 1416 of some examples performs integer based operations. In other examples, the AL circuitry 1416 also performs floating point operations. In yet other examples, the AL circuitry 1416 may include first AL circuitry that performs integer based operations and second AL circuitry that performs floating point operations. In some examples, the AL circuitry 1416 may be referred to as an Arithmetic Logic Unit (ALU). The registers 1418 are semiconductor-based structures to store data and/or instructions such as results of one or more of the operations performed by the AL circuitry 1416 of the corresponding core 1402. For example, the registers 1418 may include vector register(s), SIMD register(s), general purpose register(s), flag register(s), segment register(s), machine specific register(s), instruction pointer register(s), control register(s), debug register(s), memory management register(s), machine check register(s), etc. The registers 1418 may be arranged in a bank as shown in FIG. 14. Alternatively, the registers 1418 may be organized in any other arrangement, format, or structure including distributed throughout the core 1402 to shorten access time. The bus 1404 may implement at least one of an I2C bus, a SPI bus, a PCI bus, or a PCIe bus

Each core 1402 and/or, more generally, the microprocessor 1400 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1400 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 15 is a block diagram of another example implementation of the processor circuitry 1312 of FIG. 13. In this example, the processor circuitry 1312 is implemented by FPGA circuitry 1500. The FPGA circuitry 1500 can be used, for example, to perform operations that could otherwise be performed by the example microprocessor 1400 of FIG. 14 executing corresponding machine readable instructions. However, once configured, the FPGA circuitry 1500 instantiates the machine readable instructions in hardware and, thus, can often execute the operations faster than they could be performed by a general purpose microprocessor executing the corresponding software.

More specifically, in contrast to the microprocessor 1400 of FIG. 14 described above (which is a general purpose device that may be programmed to execute some or all of the machine readable instructions represented by the flowcharts of FIGS. 8-12 but whose interconnections and logic circuitry are fixed once fabricated), the FPGA circuitry 1500 of the example of FIG. 15 includes interconnections and logic circuitry that may be configured and/or interconnected in different ways after fabrication to instantiate, for example, some or all of the machine readable instructions represented by the flowcharts of FIGS. 8-12. In particular, the FPGA 1500 may be thought of as an array of logic gates, interconnections, and switches. The switches can be programmed to change how the logic gates are interconnected by the interconnections, effectively forming one or more dedicated logic circuits (unless and until the FPGA circuitry 1500 is reprogrammed). The configured logic circuits enable the logic gates to cooperate in different ways to perform different operations on data received by input circuitry. Those operations may correspond to some or all of the software represented by the flowcharts of FIGS. 8-12. As such, the FPGA circuitry 1500 may be structured to effectively instantiate some or all of the machine readable instructions of the flowcharts of FIGS. 8-12 as dedicated logic circuits to perform the operations corresponding to those software instructions in a dedicated manner analogous to an ASIC. Therefore, the FPGA circuitry 1500 may perform the operations corresponding to the some or all of the machine readable instructions of FIGS. 8-12 faster than the general purpose microprocessor can execute the same.

In the example of FIG. 15, the FPGA circuitry 1500 is structured to be programmed (and/or reprogrammed one or more times) by an end user by a hardware description language (HDL) such as Verilog. The FPGA circuitry 1500 of FIG. 15, includes example input/output (I/O) circuitry 1502 to obtain and/or output data to/from example configuration circuitry 1504 and/or external hardware (e.g., external hardware circuitry) 1506. For example, the configuration circuitry 1504 may implement interface circuitry that may obtain machine readable instructions to configure the FPGA circuitry 1500, or portion(s) thereof. In some such examples, the configuration circuitry 1504 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1506 may implement the microprocessor 1400 of FIG. 14. The FPGA circuitry 1500 also includes an array of example logic gate circuitry 1508, a plurality of example configurable interconnections 1510, and example storage circuitry 1512. The logic gate circuitry 1508 and interconnections 1510 are configurable to instantiate one or more operations that may correspond to at least some of the machine readable instructions of FIGS. 8-12 and/or other desired operations. The logic gate circuitry 1508 shown in FIG. 15 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1508 to enable configuration of the electrical structures and/or the logic gates to form circuits to perform desired operations. The logic gate circuitry 1508 may include other electrical structures such as look-up tables (LUTs), registers (e.g., flip-flops or latches), multiplexers, etc.

The interconnections 1510 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1508 to program desired logic circuits.

The storage circuitry 1512 of the illustrated example is structured to store result(s) of the one or more of the operations performed by corresponding logic gates. The storage circuitry 1512 may be implemented by registers or the like. In the illustrated example, the storage circuitry 1512 is distributed amongst the logic gate circuitry 1508 to facilitate access and increase execution speed.

The example FPGA circuitry 1500 of FIG. 15 also includes example Dedicated Operations Circuitry 1514. In this example, the Dedicated Operations Circuitry 1514 includes special purpose circuitry 1516 that may be invoked to implement commonly used functions to avoid the need to program those functions in the field. Examples of such special purpose circuitry 1516 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1500 may also include example general purpose programmable circuitry 1518 such as an example CPU 1520 and/or an example DSP 1522. Other general purpose programmable circuitry 1518 may additionally or alternatively be present such as a GPU, an XPU, etc., that can be programmed to perform other operations.

Although FIGS. 14 and 15 illustrate two example implementations of the processor circuitry 1312 of FIG. 13, many other approaches are contemplated. For example, as mentioned above, modern FPGA circuitry may include an on-board CPU, such as one or more of the example CPU 1520 of FIG. 15. Therefore, the processor circuitry 1312 of FIG. 13 may additionally be implemented by combining the example microprocessor 1400 of FIG. 14 and the example FPGA circuitry 1500 of FIG. 15. In some such hybrid examples, a first portion of the machine readable instructions represented by the flowcharts of FIGS. 8-12 may be executed by one or more of the cores 1402 of FIG. 14 and a second portion of the machine readable instructions represented by the flowcharts of FIGS. 8-12 may be executed by the FPGA circuitry 1500 of FIG. 15.

In some examples, the processor circuitry 1312 of FIG. 13 may be in one or more packages. For example, the processor circuitry 1400 of FIG. 14 and/or the FPGA circuitry 1500 of FIG. 15 may be in one or more packages. In some examples, an XPU may be implemented by the processor circuitry 1312 of FIG. 13, which may be in one or more packages. For example, the XPU may include a CPU in one package, a DSP in another package, a GPU in yet another package, and an FPGA in still yet another package.

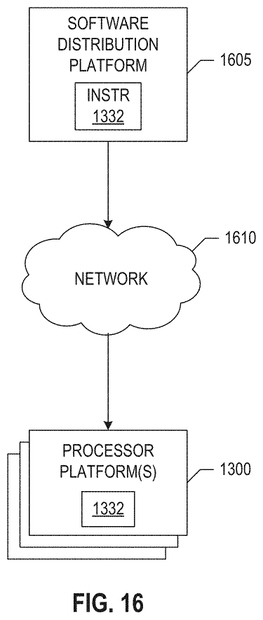

A block diagram illustrating an example software distribution platform 1605 to distribute software such as the example machine readable instructions 1332 of FIG. 13 to hardware devices owned and/or operated by third parties is illustrated in FIG. 16. The example software distribution platform 1605 may be implemented by any computer server, data facility, cloud service, etc., capable of storing and transmitting software to other computing devices. The third parties may be customers of the entity owning and/or operating the software distribution platform 1605. For example, the entity that owns and/or operates the software distribution platform 1605 may be a developer, a seller, and/or a licensor of software such as the example machine readable instructions 1332 of FIG. 13. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1332, which may correspond to the example machine readable instructions 800, 810, 812, 1100, 1200 of FIGS. 8-12, as described above. The one or more servers of the example software distribution platform 1605 are in communication with a network 1610, which may correspond to any one or more of the Internet and/or any of the example networks 108 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1332 from the software distribution platform 1605. For example, the software, which may correspond to the example machine readable instructions 800, 810, 812, 1100, 1200 of FIGS. 8-12, may be downloaded to the example processor platform 1300, which is to execute the machine readable instructions 1332 to implement the audience metrics generator circuitry 126. In some example, one or more servers of the software distribution platform 1605 periodically offer, transmit, and/or force updates to the software (e.g., the example machine readable instructions 1332 of FIG. 13) to ensure improvements, patches, updates, etc., are distributed and applied to the software at the end user devices.

From the foregoing, it will be appreciated that example systems, methods, apparatus, and articles of manufacture have been disclosed that determine unknown census demographic information for multiple dimensions. The multiple dimensions correspond to media accesses or events such as, for example, videos (e.g., video 1, video 2 and video 3). The unknown census demographic information is determined based on known census data and known panel data. The disclosed systems, methods, apparatus, and articles of manufacture improve the efficiency of using a computing device by solving for census-level audience sizes, impression counts, and durations for multiple dimensions and multiple demographics with one set of constraint equations and bounds. As such, examples disclosed herein determine census-level audience sizes, impression counts, and durations for multiple dimensions and multiple demographics without the need to solve multiple sets of equations, each corresponding to a single dimension or a single demographic. Thus, reducing the number of sets of equations to be solved to a single set of equations reduces computing resources needed to solve for the census-level demographic audience metrics for multiple dimensions and multiple demographics. The disclosed systems, methods, apparatus, and articles of manufacture are accordingly directed to one or more improvement(s) in the operation of a machine such as a computer or other electronic and/or mechanical device.

Example methods and apparatus to determine census information of events are disclosed herein. Further examples and combinations thereof include the following:

Example 1 includes an apparatus including at least one memory; instructions; and processor circuitry to execute the instructions to at least: select a plurality of constraint equations based on census audience measurement data corresponding to a first demographic group and a second demographic group; determine bounds for multipliers for ones of the constraint equations based on the census audience measurement data; determine a value for ones of the multipliers based on the bounds, the value to satisfy the constraint equations; determine first census audience measurement information and second census audience measurement information based on the multipliers, panel audience measurement data, and the census audience measurement data, the first census audience measurement information corresponding to the first demographic group, the second census audience measurement information corresponding to the second demographic group; and generate a report including the first census audience measurement information and the second census audience measurement information.

Example 2 includes the apparatus of example 1, wherein the census audience measurement data and the panel audience measurement data correspond to a plurality of media items.

Example 3 includes the apparatus of example 1, wherein the census audience measurement data includes an audience size, an impression count, and duration data.

Example 4 includes the apparatus of example 1, wherein the processor circuitry is to execute the instructions to determine, based on the multipliers, the panel audience measurement data, and the census audience measurement data, a first deduplicated census audience size for the first demographic group and a second deduplicated census audience size for the second demographic group.

Example 5 includes the apparatus of example 1, wherein the processor circuitry is to execute the instructions to determine third census audience measurement information, the third census audience measurement information based on a total of the first census audience measurement information and the second census audience measurement information.

Example 6 includes the apparatus of example 1, wherein at least a first one of the constraint equations is based on a sum of census impression counts across demographics and at least a second one of the constraint equations is based on a sum of census duration data across the demographics.

Example 7 includes the apparatus of example 1, wherein the first census audience measurement information and the second census audience measurement information are not included in the census audience measurement data.

Example 8 includes the apparatus of example 1, wherein the multipliers are Lagrange multipliers.

Example 9 includes an apparatus including statistics generator circuitry to select a plurality of constraint equations based on census audience measurement data corresponding to a first demographic group and a second demographic group; bounds generator circuitry to determine bounds for multipliers for ones of the constraint equations based on the census audience measurement data; multiplier controller circuitry to determine a value for ones of the multipliers based on the bounds, the value to satisfy the constraint equations; census-level metrics generator circuitry to determine first census audience measurement information and second census audience measurement information based on the multipliers, panel audience measurement data, and the census audience measurement data, the first census audience measurement information corresponding to the first demographic group, the second census audience measurement information corresponding to the second demographic group; and reporter circuitry to generate a report including the first census audience measurement information and the second census audience measurement information.

Example 10 includes the apparatus of example 9, wherein the census audience measurement data and the panel audience measurement data correspond to a plurality of media items.

Example 11 includes the apparatus of example 9, wherein the census data includes an audience size, an impression count, and duration data.

Example 12 includes the apparatus of example 9, further including metrics calculator circuitry to determine, based on the multipliers, the panel audience measurement data, and the census audience measurement data, a first deduplicated census audience size for the first demographic group and a second deduplicated census audience size for the second demographic group.

Example 13 includes the apparatus of example 9, wherein the census-level metrics generator circuitry is to determine third census audience measurement information, the third census audience measurement information based on a total of the first census audience measurement information and the second census audience measurement information.

Example 14 includes the apparatus of example 9, wherein at least a first one of the constraint equations is based on a sum of census impression counts across demographics and at least a second one of the constraint equations is based on a sum of census duration data across the demographics.

Example 15 includes the apparatus of example 9, wherein the first census audience measurement information and the second census audience measurement information are not included in the census audience measurement data.

Example 16 includes the apparatus of example 9, wherein the multipliers are Lagrange multipliers.

Example 17 includes a non-transitory computer readable medium comprising instructions that when executed cause at least one processor to select a plurality of constraint equations based on census audience measurement data corresponding to a first demographic group and a second demographic group; determine bounds for multipliers for ones of the constraint equations based on the census audience measurement data; determine a value for ones of the multipliers based on the bounds, the value to satisfy the constraint equations; determine first census audience measurement information and second census audience measurement information based on the multipliers, panel audience measurement data, and the census audience measurement data, the first census audience measurement information corresponding to the first demographic group, the second census audience measurement information corresponding to the second demographic group; and generate a report including the first census audience measurement information and the second census audience measurement information.

Example 18 includes the non-transitory computer readable medium of example 17, wherein the census audience measurement data and the panel audience measurement data correspond to a plurality of media items.

Example 19 includes the non-transitory computer readable medium of example 17, wherein the census audience measurement data includes an audience size, an impression count, and duration data.

Example 20 includes the non-transitory computer readable medium of example 17, wherein the at least one processor is to determine, based on the multipliers, the panel audience measurement data, and the census audience measurement data, a first deduplicated census audience size for the first demographic group and a second deduplicated census audience size for the second demographic group.

Example 21 includes the non-transitory computer readable medium of example 17, wherein the at least one processor is to determine third census audience measurement information, the third census audience measurement information based on a total of the first census audience measurement information and the second census audience measurement information.

Example 22 includes the non-transitory computer readable medium of example 17, wherein at least a first one of the constraint equations is based on a sum of census impression counts across demographics and at least a second one of the constraint equations is based on a sum of census duration data across the demographics.

Example 23 includes the non-transitory computer readable medium of claim 17, wherein the first census audience measurement information and the second census audience measurement information are not included in the census audience measurement data.

Example 24 includes the non-transitory computer readable medium of claim 17, wherein the multipliers are Lagrange multipliers.

Example 25 includes an method including selecting a plurality of constraint equations based on census audience measurement data corresponding to a first demographic group and a second demographic group; determining bounds for multipliers for ones of the constraint equations based on the census audience measurement data; determining a value for ones of the multipliers based on the bounds, the value to satisfy the constraint equations; determining first census audience measurement information and second census audience measurement information based on the multipliers, panel audience measurement data, and the census audience measurement data, the first census audience measurement information corresponding to the first demographic group, the second census audience measurement information corresponding to the second demographic group; and generating a report including the first census audience measurement information and the second census audience measurement information.

Example 26 includes the method of example 25, wherein the census audience measurement data and the panel audience measurement data correspond to a plurality of media items.

Example 27 includes the method of example 25, wherein the census data includes an audience size, an impression count, and duration data.

Example 28 includes the method of example 25, further including determining, based on the multipliers, the panel audience measurement data, and the census audience measurement data, a first deduplicated census audience size for the first demographic group and a second deduplicated census audience size for the second demographic group.

Example 29 includes the method of example 25, further including determining third census audience measurement information, the third census audience measurement information based on a total of the first census audience measurement information and the second census audience measurement information.

Example 30 includes the method of example 25, wherein at least a first one of the constraint equations is based on a sum of census impression counts across demographics and at least a second one of the constraint equations is based on a sum of census duration data across the demographics.

Example 31 includes the method of example 25, wherein the first census audience measurement information and the second census audience measurement information are not included in the census audience measurement data.

Example 32 includes the method of example 25, wherein the multipliers are Lagrange multipliers.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory;
instructions; and
processor circuitry to execute the instructions to at least:
select a plurality of constraint equations based on census audience measurement data corresponding to a first demographic group and a second demographic group;
determine bounds for multipliers for ones of the constraint equations based on the census audience measurement data;
determine a value for ones of the multipliers based on the bounds, the value to satisfy the constraint equations;
determine first census audience measurement information and second census audience measurement information based on the multipliers, panel audience measurement data, and the census audience measurement data, the first census audience measurement information corresponding to the first demographic group, the second census audience measurement information corresponding to the second demographic group; and
generate a report including the first census audience measurement information and the second census audience measurement information.

2. The apparatus of claim 1, wherein the census audience measurement data and the panel audience measurement data correspond to a plurality of media items.

3. The apparatus of claim 1, wherein the census audience measurement data includes an audience size, an impression count, and duration data.

4. The apparatus of claim 1, wherein the processor circuitry is to execute the instructions to determine, based on the multipliers, the panel audience measurement data, and the census audience measurement data, a first deduplicated census audience size for the first demographic group and a second deduplicated census audience size for the second demographic group.

5. (canceled)

6. The apparatus of claim 1, wherein at least a first one of the constraint equations is based on a sum of census impression counts across demographics and at least a second one of the constraint equations is based on a sum of census duration data across the demographics.

7. The apparatus of claim 1, wherein the first census audience measurement information and the second census audience measurement information are not included in the census audience measurement data.

8. The apparatus of claim 1, wherein the multipliers are Lagrange multipliers.

9-16. (canceled)

17. A non-transitory computer readable medium comprising instructions that when executed cause at least one processor to:
select a plurality of constraint equations based on census audience measurement data corresponding to a first demographic group and a second demographic group;
determine bounds for multipliers for ones of the constraint equations based on the census audience measurement data;
determine a value for ones of the multipliers based on the bounds, the value to satisfy the constraint equations;
determine first census audience measurement information and second census audience measurement information based on the multipliers, panel audience measurement data, and the census audience measurement data, the first census audience measurement information corresponding to the first demographic group, the second census audience measurement information corresponding to the second demographic group; and
generate a report including the first census audience measurement information and the second census audience measurement information.

18. The non-transitory computer readable medium of claim 17, wherein the census audience measurement data and the panel audience measurement data correspond to a plurality of media items.

19. The non-transitory computer readable medium of claim 17, wherein the census audience measurement data includes an audience size, an impression count, and duration data.

20. The non-transitory computer readable medium of claim 17, wherein the at least one processor is to determine, based on the multipliers, the panel audience measurement data, and the census audience measurement data, a first deduplicated census audience size for the first demographic group and a second deduplicated census audience size for the second demographic group.

21. The non-transitory computer readable medium of claim 17, wherein the at least one processor is to determine third census audience measurement information, the third census audience measurement information based on a total of the first census audience measurement information and the second census audience measurement information.

22. The non-transitory computer readable medium of claim 17, wherein at least a first one of the constraint equations is based on a sum of census impression counts across demographics and at least a second one of the constraint equations is based on a sum of census duration data across the demographics.

23. (canceled)

24. The non-transitory computer readable medium of claim 17, wherein the multipliers are Lagrange multipliers.

25. An method comprising:
selecting a plurality of constraint equations based on census audience measurement data corresponding to a first demographic group and a second demographic group;
determining bounds for multipliers for ones of the constraint equations based on the census audience measurement data;
determining a value for ones of the multipliers based on the bounds, the value to satisfy the constraint equations;
determining first census audience measurement information and second census audience measurement information based on the multipliers, panel audience measurement data, and the census audience measurement data, the first census audience measurement information corresponding to the first demographic group, the second census audience measurement information corresponding to the second demographic group; and
generating a report including the first census audience measurement information and the second census audience measurement information.

26. The method of claim 25, wherein the census audience measurement data and the panel audience measurement data correspond to a plurality of media items.

27. The method of claim 25, wherein the census audience measurement data includes an audience size, an impression count, and duration data.

28. The method of claim 25, further including determining, based on the multipliers, the panel audience measurement data, and the census audience measurement data, a first deduplicated census audience size for the first demographic group and a second deduplicated census audience size for the second demographic group.

29. (canceled)

30. The method of claim 25, wherein at least a first one of the constraint equations is based on a sum of census impression counts across demographics and at least a second one of the constraint equations is based on a sum of census duration data across the demographics.

31. The method of claim 25, wherein the first census audience measurement information and the second census audience measurement information are not included in the census audience measurement data.

32. The method of claim 25, wherein the multipliers are Lagrange multiplier.
